(19) United States
(12) Patent Application Publication
(10) Pub. No.: US 2025/0045528 A1
(43) Pub. Date: Feb. 6, 2025

(54) SYSTEMS AND METHODS FOR AUTOMATING PROPERTY MANAGEMENT TASKS

(71) Applicant: AppFolio, Inc., Goleta, CA (US)

(72) Inventors: Christfried Hermann Focke, Zurich (CH); Jorge Ezequiel Esposito, Santa Barbara, CA (US); Theodore Chung Hung Ho, Goleta, CA (US); Matthew Brian Schofield, Buena, NJ (US); Ari Polakof Fernandez, San Francisco, CA (US); Thoralf Soeren Thust, Santa Barbara, CA (US); Matthew James Baird, Belmont, CA (US); Venkata Vikas Varma Nallaparaju, Durham, NC (US)

(21) Appl. No.: 18/537,793

(22) Filed: Dec. 12, 2023

Related U.S. Application Data
(60) Provisional application No. 63/530,935, filed on Aug. 4, 2023.

(51) Int. Cl. G06F 40/35; G06F 40/284; G06Q 50/163

(52) U.S. Cl. CPC G06F 40/35; G06F 40/284; G06Q 50/163; H04L 51/02

(57) ABSTRACT

A system and method are provided for processing a user request and completing associated tasks within use of a property management software system (PMSS). A chat module of the PMSS may intake and process a user request, route the request to one or more appropriate support modules of several available support modules, receive a responsive communication from the support modules once a support operation has been performed, and generate and deliver a response to the user request. The system, chat modules, and support modules may leverage a generative AI model to assist in routing the request, executing support operations, and forming a response to the request.

### CROSS-REFERENCE AND RELATED APPLICATIONS

This application claims the benefit of U.S. Provisional Patent Application No. 63/530,935; filed on Aug. 4, 2023, the entire contents of which are hereby incorporated by reference herein.

### TECHNICAL FIELD

Aspects and implementations of the present disclosure relate systems and methods for automating tasks associated with property management.

### BACKGROUND

Real estate (RE) owners who wish to lease their properties with the goal of generating rental income will need to manage the daily operations, either by themselves or by hiring a separate property management (PM) company. PM agents (e.g., a PM operator, administrator, or company) will use property management software systems (PMSS) to aid in the operations of their business, so as to improve efficiencies by automating routine and repetitive tasks. Such automation can play a critical role for an owner, especially as a particular real-estate portfolio grows beyond a certain point. By leveraging sophisticated record-keeping and task-management software, PMSSs support PM agents through database management, finance management, task management, and communications, as well as providing process visibility and scalability to RE owners, investors, employees, residents, and third-party vendors.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In some aspects, a method is provided. In some aspects, the method includes receiving, from a client device connected to a property management software system (PMSS), a first communication indicating a request pertaining to a PMSS, determining a category type associated with the request, routing, using a chat module, the first communication to a first support module configured to perform support operations associated with the category type of the request, performing, via the first support module, a first support operation associated with the request, receiving, at the chat module, a first machine communication from the first support module associated with an output of the first support operation, providing, using the chat module, the first communication and first machine communication as an input to a generative AI model, obtaining an output of the generative AI model, and providing, using the output of the generative AI model, a response to the indicated request through a user interface (UI) of the client device.

In some aspects, a system is provided. In some aspects, the system includes a memory device and a processing device communicatively coupled to the memory device. In some aspects, the processing device is to receive, from a client device connected to a property management software system (PMSS), a device communication indicating a request pertaining to a PMSS; determine a category type associated with the request, route, using a chat module, the communication to a support module configured to perform support operations associated with the category type of the request, perform, via the support module, one or more support operations associated with the request, receive, at the chat module, a machine communication from the support module associated with an output of one or more performed support operations, provide, using the chat module, the device communication and machine communication as an input to a generative AI model, obtain an output of the generative AI model, and provide, using the output of the generative AI model, a response to the indicated request through a user interface (UI) of the client device.

In some aspects, a non-transitory computer readable storage medium is provided. In some aspects, the non-transitory computer readable storage medium includes instructions that, when executed by a processing device, causes the processing device to perform operations including receiving, from a client device connected to a property management software system (PMSS), a device communication indicating a request pertaining to a PMSS, determining a category type associated with the request, routing, using a chat module, the communication to a support module configured to perform support operations associated with the category type of the request, performing, via the support module, one or more support operations associated with the request, receiving, at the chat module, a machine communication from the support module associated with an output of one or more performed support operations, providing, using the chat module, the device communication and machine communication as an input to a generative AI model, obtaining an output of the generative AI model, and providing, using the output of the generative AI model, a response to the indicated request through a user interface (UI) of the client device.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture capable of supporting a property management software system (PMSS), in accordance with embodiments of the present disclosure.

FIG. 2 illustrates example support processes for responding to a user query made within the system of FIG. 1, in accordance with embodiments of the present disclosure.

FIG. 3A illustrates an example process for routing a user query made within the system of FIG. 1 to a support module, in accordance with embodiments of the present disclosure.

FIG. 3B illustrates an example process for performing support operations within the system of FIG. 1, in accordance with embodiments of the present disclosure.

FIG. 4 illustrates an example user interface (UI) for the system of FIG. 1, in accordance with some embodiments of the present disclosure.

FIG. 5 illustrates a flow diagram of an example method for PMSSs users to interface with the PMSSs system, in accordance with some embodiments of the present disclosure.

FIG. 6 illustrates a high-level component diagram of an example system architecture for a generative machine learning model, in accordance with one or more aspects of the disclosure.

FIG. 7 depicts a block diagram of an example processing device operating in accordance with implementations of the present disclosure.

### DETAILED DESCRIPTION

Conventional property management software systems (PMSSs) face some challenges and limitations when providing and automating services to real estate (RE) owners. By way of examples, such challenges can include the need for customizations that are too natural, or advanced, for conventional PMSSs to produce, as well as addressing the breadth, scale, and complexities of property management (PM) tasks required of a RE owner.

As background to some limitations, today, many PMSSs provide a web-based interface for PM agents (e.g. PM operators, or staff) to manually perform PM tasks. PM tasks may be completed through manipulating PM information and operating a complex set of pages, menus, and forms. More specifically, such PM tasks can include generating listings for RE units, handling delinquencies, reconciling bank accounts, renewing leases, managing maintenance work orders, or generating reports, etc.

Such tasks are often repetitive and predictable in nature, but may incorporate constraints or requirements that current PMSSs are unable to meet. For example, common PM tasks may require customization based on a specific circumstance outside the purview of a PMSS, such as a need for custom and natural elements within important communications or the incorporation of impacting information or events, outside the PMSS's field of view. Such constraints make it challenging to automate PM tasks with rigid software systems, and so, often rely on a human agent to manually manipulate data or complete tasks. Such manual human engagement can increase duration for a task, occupy valuable human capital and material resources, and otherwise inject latency, error, and obscurity into existing PM systems.

Furthermore, the number and breadth of tasks performed by a PM agent can inject complexity into a correspondingly powerful PMSS and associated processes. This added scale and complexity can become overwhelming, especially for new users of a PMSS, or in dealing with rarely occurring tasks and situations. Such complexity can sometimes negate the added efficiency, accuracy, and other benefits commonly associated with task automation.

In addition, a sequence of PM tasks and their timing (further referred to herein as “workflows”) often needs to be individualized, while maintaining elements of repeatability. For example, PM workflows are often associated with recurring PM events like move-outs, renewals, or rent collections. A particular PM agent may need to individualize their specific workflows (i.e. a PM “playbook”) for these events, to address their unique circumstances and constraints. Such individualized workflows may introduce requirements for additional training or supervision for associated agents or staff, to maintain consistent experiences and expectations for residents and stakeholders. Implementing mechanisms for adding such training or supervision can engage substantial human capital, require significant time-investment, and otherwise strain a PM agent or organization's bandwidth.

Aspects of the present disclosure relate to a PMSS leveraging the use of one or more artificial intelligence (AI) models for automating and supporting PM tasks. An input feature such as a chat interface may be presented to a user of the PMSS, to facilitate text communications between the user and the PMSS and supporting modules. The user may input requests, commands, questions, or data, and leverage several functionalities of the chat interface and features, to accomplish tasks associated with PM, as will be further described below.

In some embodiments, the above mentioned, one or more AI model may leverage, be, or include, an intelligent agent, such as one or more large language models (LLMs) that may be fine-tuned or instructed with contextual information to give and receive instructions in a conversational setting and tone, as well as perform tasks pertaining to a set of instructions pertaining to the model's purpose and abilities. In some embodiments, the one or more AI models may be fine-tuned on a specific domain of a PM business unit (e.g., the financial unit). In some embodiments, the one or more AI models may be fine-tuned for supporting PMSSs in general.

In some embodiments, aspects of the present disclosure address the above and other deficiencies by implementing a persistent input feature (e.g., a persistent chat interface (CI)) alongside a traditional user interface (UI) of a PMSS to facilitate user engagement with an AI model. In some embodiments, the input feature may allow a user to interface with (e.g. provide a user query) to one or more AI models.

In some embodiments, the system may include a validation component (in some embodiments described herein, referred to as “query validator” or “query validation module”) that augments and/or validates a user query, prior to query handling. In some embodiments, a user query may first be validated by the query validator, before being processed and routed via a chat module (or a similar version of a query router).

In some embodiments, the system may intake a user query via the input feature (e.g., chat interface), analyze the query (with or without the AI model functionalities), validate and/or sanitize the query, and route the user query to an appropriate support module from several available support modules, that each perform further processing and sub operations associated with the query. In some embodiments, the chat module may route the query to more than one support module, and then collect responses from one or more support modules to return to the UI for rendering. In alternate embodiments, the support modules themselves may return a response to the UI.

In some embodiments, several support modules may be associated with the system. A single support module, for example, may perform more focused tasks or support operations, including further subprocesses, or retrieval of data associated with the query (again, with or without the AI model functionalities). In some embodiments, the support modules may provide retrieved data, and/or confirmations that tasks have been performed, through a communication sent back to the chat module. The chat module may then use such a communication, together with an AI model, to formulate a response for replying to the user query.

For example, in some embodiments, a specific support module may retrieve data associated with a given user query, by computing vector representation of the user query (e.g. a query embedding), and using such to scan a vector database. In some embodiments, such a support module may compare vector similarities, and based on such, retrieve a corresponding data segment of the vectorized database corresponding to the query embedding. Data portions peripheral (e.g. nearby) the corresponding data segment may also be retrieved from the vectorized database and added as context for the system.

A response communication from a support module may contain information for predefined UI visual elements (e.g., widgets), populated with information pertaining to the user query that can be directly rendered in the user interface. The UI visual elements may include elements such as rendering for a simple message, a link, or a table, and may contain markdown instructions for advanced rendering. It further may contain machine readable information that can be used to augment the user experience. For example a data query may contain columns such as “tenant.name” that can be used in a follow up step to personalize message templates to be sent to a list of tenants.

In some embodiments, a filtering step may be applied to the support module response, or to the user query, if the amount of contextual information exceeds the allowed context window of the AI model, or to otherwise optimize computation for elements such as cost and latency. Such a filtering step may be implemented with a specialized filter request to the AI model, or via a vector representation (e.g., an embedding, or a latent-space vector representation) of at least a portion of the context, which may be extracted from a vector database.

In some embodiments, the system may keep conversation context over multiple turns (e.g., multiple user queries, and corresponding multiple system generated responses), such that a user can iteratively refine their query (e.g. request) in the context of previous messages and/or model outputs.

While PM agents can use the CI to generate ad-hoc workflows, a PM agent may desire a mechanism with which to generate a novel, and customized workflow (i.e., repeat the same or similar steps without specifying such a process on every implementation). For example, a workflow that queries for delinquent tenants, sends them reminders, and/or begins an eviction process would have to be repeated monthly.

In order to provide this functionality, in one implementation a separate workflow builder interface (WBI) may be created. In one embodiment, it would contain a series of prebuilt step templates that make up common workflows, such as the delinquency workflow above, which a user can modify with custom parameters. Here a workflow can contain conditional logic and loops. A prebuilt step could for example consist of just a note with a task someone has to execute outside the PMSS, or could contain more complex actions. In addition, the steps may contain triggers for external events. When such an external event is received one embodiment may use again an LLM to interpret it and decide or suggest the next step, such as deciding which branch to execute, or even generate follow-up steps dynamically.

In another embodiment a user would use the CI as “playground” to iteratively refine a query or query template, then move it over to the WBI, either via a button or drag and drop. In one embodiment, a user may reuse the potentially templatized query that was generated from the data query or API support module and adjust it to generalize it for a schedule. For example, a query may contain a specific date range that will get replaced with a programmatically adjusted date range to generalize it for future executions. The WBI would allow combining it with other prebuilt steps or steps from previous iterations of the same process. A user would be able to visualize, modify and test the workflow in the WBI, as well as set permissions on which user is allowed to execute or see results of the workflow execution. Together with a traditional workflow execution engine these steps may then be executed continuously, on a schedule, or on demand.

In order to supervise and step into parts of the workflow execution, either to correct it or for actions that are outside of the PMSS (e.g. getting the keys from a resident) a PM will have a separate workflow management dashboard (WMD). Here a PM agent (e.g. a user of the WMD) can view, for example, which activities have been executed, whom they have been executed by, which activities are queued, and whether a workflow is blocked. An agent may also get notifications and an audit log. A more sophisticated analytics tool may be built on top of this, e.g. to see average workflow execution times or statistics on how often certain workflows are blocked.

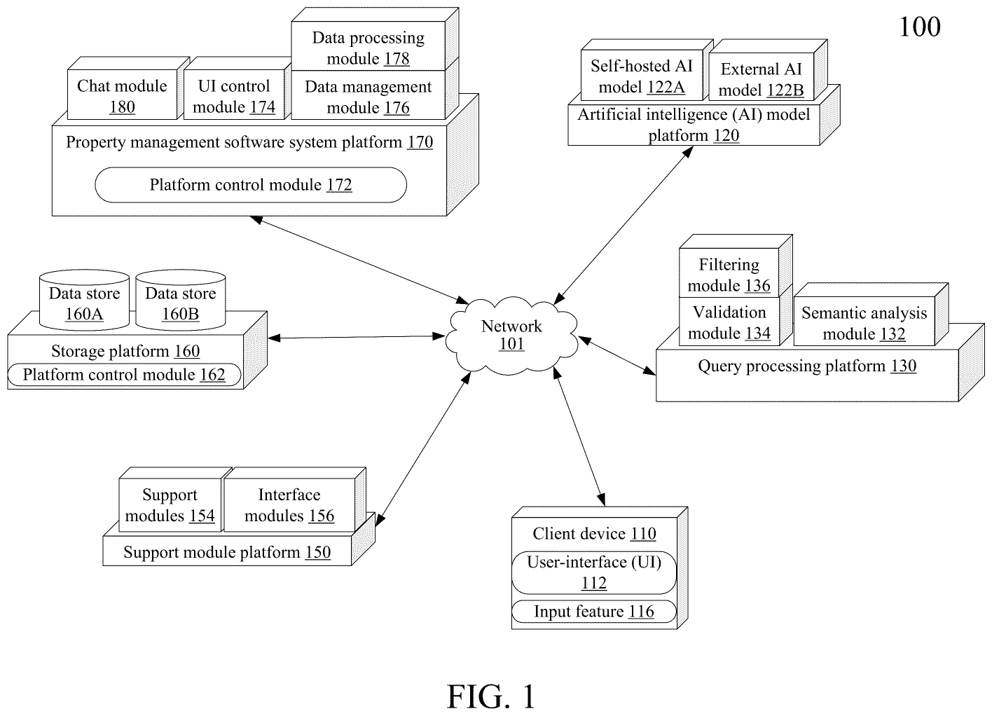

Turning now to the figures, FIG. 1 illustrates an example system architecture capable of supporting a property management software system (PMSS), in accordance with embodiments of the present disclosure. The system architecture 100 (also referred to as “system” or “PMSS” herein) includes one or more client device(s) (e.g. client device 110), an artificial intelligence (AI) model platform 120, a user query processing platform 130, a support module platform 150, a storage platform 160, and a property management software system (PMSS) platform 170, each connected to a network 101. In some embodiments, client device 110, artificial intelligence (AI) model platform 120, user query processing platform 130, router platform 140, support module platform 150, storage platform 160, and PMSS platform 170 can include, can be, or can otherwise be connected to one or more computing devices, (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components capable of connecting to system 100.

In some embodiments, network 101 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In some embodiments of the system, the system 100 may include a property management software system (PMSS) platform 170 for hosting the PMSS, that may support a control module (e.g., control module 172), for performing overall control of modules and devices associated with the platform, a user-interface (UI) control module (e.g., UI control module 174), for performing UI generation for one or more client devices, and other processes associated with the UI that will be presented to a user, a data management module 176, that may gather and manage data (e.g. such as data gathered from support module platform 150 or storage platform 160 for chat functionality), a data processing module (e.g., data processing module 178), that may process, transmit, and receive, incoming and outgoing data, and a chat module 180, that may host, process, route and provide responses to user inputs associated with the chat functionalities. These components can work collaboratively, and communicate internally, or externally (e.g. to further systems and/or through APIs), to facilitate PMSS capabilities for agents and users across a range of client devices.

As described above, platform 170 can facilitate connection of client devices (e.g. client device 110) to the system 100. Platform 170 can facilitate connecting any number of client devices associated with any number of users. In some embodiments, platform 170 can support textual transfer capabilities, or any data transfer of any data types relevant or associated with a PM task. In embodiments, platform 170 can synchronize and deliver digital communications, such as text, impressions, emoji, audio, video, etc., and other kinds of communications data to client devices with minimal latency.

In some embodiments platform 170 interfaces with other platforms of the system 100 and may act as a bridge, facilitating the low-latency exchange of communications data between client devices during use of the PMSS. In some embodiments, platform 170 can implement the rules and/or protocols for facilitating client device connections, and can provide supporting structures, such as UIs and/or communications management for client devices connected to the system.

Platform control module 172 may orchestrate the overall functioning of the PMSS platform 170. In some cases, platform control module 172 can include algorithms and processes to direct the setup, data transfer, and processing required for providing PMSS services to a user. For example, when a user initiates engagement with the PMSS, the control module 172 may initiate and manage the associated process, including allocating resources, determining routing pathways for data streams, managing permissions, and so forth interact with client devices to establish and maintain reliable connections. Control module 172 may also control internal modules of (e.g. that are within) the PMSS platform 170.

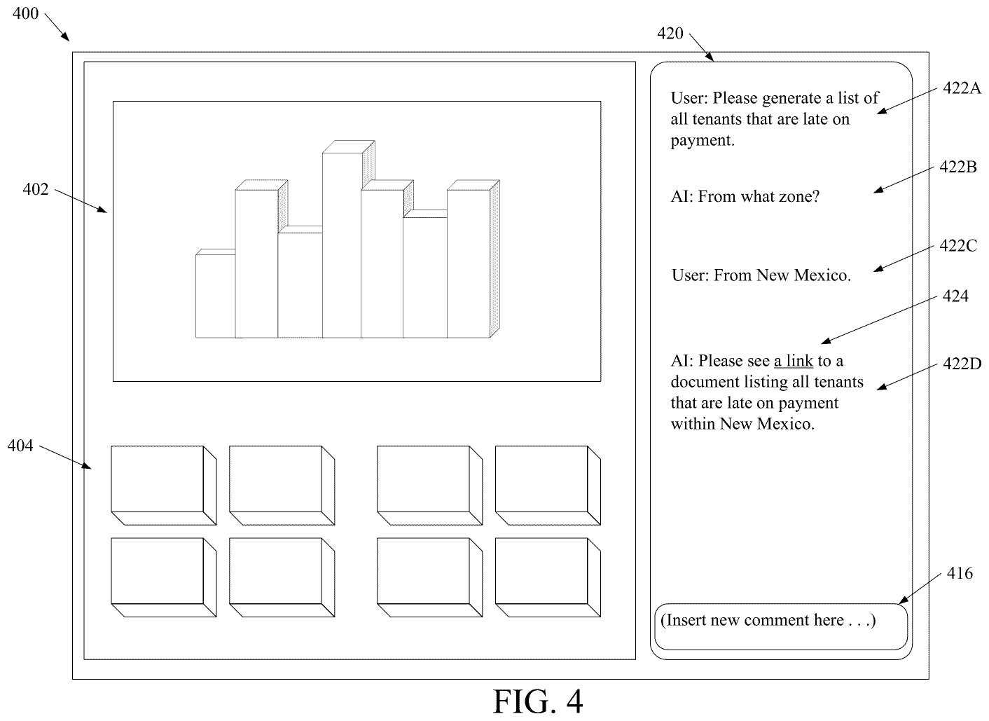

UI control module 174 may perform user-display functionalities of the system such as generating, modifying, and monitoring the individual UI(s) and associated components that are presented to users of the platform 170. For example, UI control module 174 can generate the UI(s) (e.g. graphical user-interfaces (GUIs)) that users interact with during use of the PMSS. As will be further discussed with respect to FIG. 4, a UI may include many interactive (or non-interactive) visual elements for display to a user. Such visual elements may occupy space within a UI and may be visual elements such as windows displaying video streams, windows displaying images, chat panels, file sharing options, participant lists, or control buttons for functions such as navigating the system, requesting data or documents, engaging in chat functionality, and so forth. The UI control module 174 can work to manage such a UI and associated elements, including generating, monitoring, and updating the spatial arrangement and presentation of such visual elements, as well as working to maintain functions and manage user interactions, together with the control module 172. Additionally, the UI control module 174 can adapt the interface based on the capabilities of client devices. In such a way the UI control module 174 can provide a fluid and responsive interactive experience for users of the PMSS.

In some embodiments, the data management module 176 may be responsible for the acquisition and management of data. This may include gathering and directing data received from a user of the PMSS, gathering and directing data received from support module platform 150 and/or data stores (e.g. such as data stores 160A/B) or other platforms, or connection to third-party data providers. Data management module 176 can also be responsible for communicating with external data storage (e.g. data store 160A-B and storage platform 160), to store received data, or acquire previously stored data for manipulation or transmission (outside of the chat functionalities provided by chat module 180). Thus, module 176 not only directs storage of acquired data but often also manages metadata associated with such data, including titles, descriptions, data-types, thumbnails, and more.

Data management module 176 may work hand-in-hand with data processing module 178, which may receive, process, and transmit data to and/or form associated client devices. In some cases, data processing module 178 may be equipped to receive, transmit, encode, decode, compress, or otherwise process data for efficient delivery to or from devices, modules or platforms, etc. (and as controlled by control module 172). Once the data processing module 178 has received and processed internal data (as described in previous paragraphs), it may transmit the data to associated client devices over a network (or any other connection method). Depending on the network conditions and capabilities of each client device, different versions of the same data, may be sent to different devices to ensure the best possible quality of data for each user.

Some data, such as textual input (e.g., chat inputs, comments, or other textual commands associated with the PMSS, etc.), participant reactions, and control commands may not be received by the data processing module or data management module, but instead by the control module 172 and/or chat module 180, which may process specific inputs and coordinate with other modules to perform associated tasks (e.g., update UIs, store data, update system indicators for connected devices and modules, etc.).

For example, in the case of PMSS navigation command (e.g. received via a navigation control bar, or similar implementation, of the UI), platform control module 172 may ultimately receive the navigation command, and work with the other modules of the system to effect the user navigation request. In the case of a different control command, like a selection of a document for viewing at the client device, the control module 172 may direct the data management module 176 to acquire the necessary data from storage platform 160, and direct data processing module 178 and UI control module 174 to effectively transfer such a document and its associated data to the connected client device. In such a way, transmitting, receiving, and processing of data by the PMSS platform 170 from one or more connected client devices (e.g., client device 110) may be coordinated by the control module 172 in tandem with other associated modules and platforms, as seen in FIG. 1.

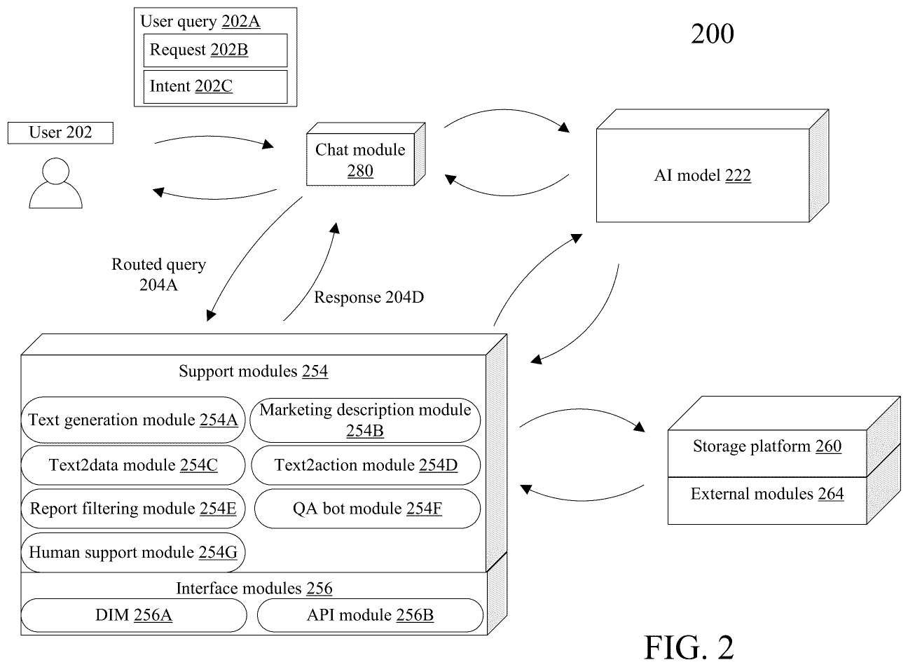

Some user inputs related to the chat functionalities of the PMSS system received from a client device 110 may require further processing (as will be described in further detail with respect to FIG. 2). If determined as necessary, the platform control module may leverage chat module 180 (or chat module 180 may receive such user inputs directly), AI models associated with the system, query processing platform, and support module platform 150 to properly engage with the chat directed user inputs.

When a user transfers a user query through the chat functionalities to the PMSS with the intent of performing a content search, such information can ultimately be transferred to, and handled, by chat module 180. Upon receiving such a query, chat module 180 may process such data internally, coordinate with AI model platform 120, query processing platform 130, and/or support module platform 150, to generate a response to such a user query. Ultimately (as will be discussed in further detail with respect to FIG. 2), chat module 180 may perform an operation, direct other modules and platforms to perform operations (e.g., such as a support operation), or communicate with external APIs to transfer instructions and data. Such operations can include, for example, retrieving a document, article, or information for display to the user, sending one or more emails, or providing a text response, etc.

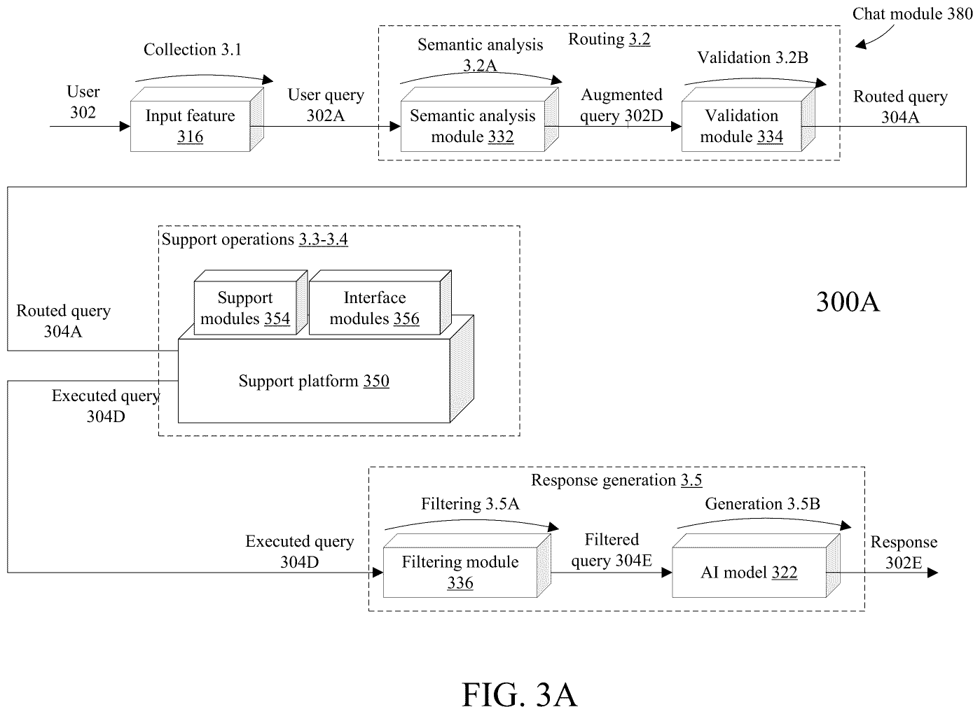

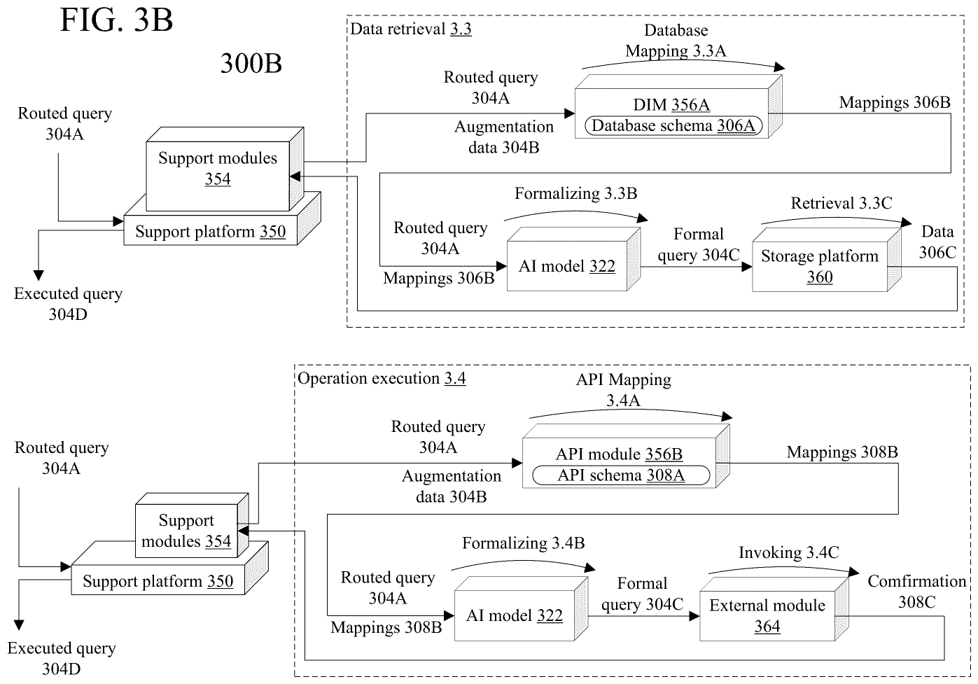

In some embodiments, chat module 180 may receive an input user query, perform semantic analysis, validate the query, filter (if necessary), and route to an appropriate support module of support modules 154 (support modules 154 may include several support modules, as will be further described with respect to FIG. 2). These processes will be further discussed with respect to FIGS. 2 and 3A-3B below.

In some embodiments, one or more client devices (e.g. client device 110) can be connected to the system 100. In some embodiments, the client device(s) can each include computing devices such as personal computers (PCs), laptops, mobile phones, smart phones, tablet computers, netbook computers, notebook computers, network-connected televisions, etc. In some embodiments, client device(s) may also be referred to as “user devices.”

Client devices, under direction by the property management system platform, when connected, can present (e.g. display) a UI to a user of a respective device. As will be discussed in further detail with respect to FIG. 4, such a UI may can include various visual elements and may be the primary mechanism by which the user engages with the PMSS platform, and the PMSS at large.

In some embodiments, client devices (e.g. client device 110) connected to the system can each include a client application (not shown in FIG. 1). In some embodiments, a client application can be an application that provides a user interface (UI) (e.g., UI 112), sometimes referred to as a graphical user interface (GUI)) for users to transmit and receive data from the system at large. In some embodiments, the system (or any associated platforms), may transmit any data, including audio, video, and textual data, to the client device. Such data that can be received by the client application for display in the UI and can include, for example, textual information, document information, information associated with the PMSS at large, or queries or decisions for which the platform requires user input.

In some embodiments, the client application (e.g. that provides the UI) can be, or can include, a web browser, a mobile application, a desktop application, etc. In one or more examples, a user of a client device can input textual data (e.g. a user query) into an input feature (e.g. input feature 116) or the client application, to provide a query to the PMSS, and associated modules.

In some embodiments, the client device may capture audio, video, and textual data from a user of the client device and transmit the captured data to the PMSS platform. Such data can include audio, video, and textual data from a user of the client device. In some embodiments, the client device may transmit the captured data to any of the system platform(s) for further processing. Such captured data can be any kind of input data associated with a conventional mouse and keyboard, or other similar input system (e.g., that associated with other types of client devices). Such data can be transmitted to any system platform and/or any of its associated modules. In an example, such captured data that can be transmitted to the PMSS platform can include, textual or PM data that a user intends for storage, inputs or directives for the PMSS and/or any of its associated modules to execute a task, or user queries for the PMSS platform to generate a response (as will be discussed in further detail with respect to FIG. 2).

As will be described in further detail with respect to FIG. 4, In some embodiments, the UI(s) can include one or more UI element(s) that support a user input feature 116 (e.g. such as a query space, or an audio feature incorporating speech-to-text capabilities). Such an input feature 116 may be used by the user to provide input or a query for the chat functionalities of the PMSS platform, or the PMSS at large.

In some embodiments, as will be discussed in further detail below, functionalities of the system 100 (and the PMSS at large) may leverage an artificial intelligence (AI) model platform 120, for accessing and communicating with an AI model (e.g., self-hosted AI model 122A and/or external AI model 122B). In some embodiments, platform 120 may include an interface (not shown in FIG. 1) for communicating to and from the AI model(s).

In some embodiments, the AI models of platform 120 may be generative large language models (LLMs) (e.g. in some embodiments the AI models of platform 120 may be an instance of Google's Bert, or OpenAI's series of ChatGPT language models, or any other LLM). As will be discussed further below, the AI model can be pre-trained, and capable of processing and responding to natural language inputs with coherent and contextually relevant text.

In some embodiments, AI model(s) may be (or may correspond to) one or more computer programs executed by processor(s) of AI model platform 120. In other embodiments, an AI model may be (or may correspond to) one or more computer programs executed across a number or combination of server machines. For example, in some embodiments, self-hosted AI model 122A may be hosted within a proprietary PMSS, or within a proprietary server or hardware system, while external AI model 122B may be any existing AI model accessible via an external API (e.g. accessible on the internet).

In some embodiments, the system 100 may leverage a query processing platform 130 for hosting query processing modules and associated functions. Query processing modules hosted by platform 130 may include semantic analysis module 132, validation module 134, and filtering module 136. In embodiments, the modules of the query processing platform may manipulate the query data and format to either prepare the data for transfer to a specific platform, module, or API, or extract information about the query, so as to make determinations about how to further process the query. These modules and processes, as well as others, will be further discussed with respect to FIG. 3A below. Suffice to say now, that the modules and functionalities of platform 130 may be accessed by other modules and platforms of system 100.

In some embodiments of the system, as will be discussed in further detail below with respect to FIGS. 2, and 3A-3B, the system 100 may include a support module platform 150 for performing support operations and responding to user queries (e.g., that have been routed via chat module 180). Support module platform 150 may include support modules 154, and interface modules 156. Support modules 154 may be a variety of support modules (as will be discussed below) for performing support operations. Support modules 154 may leverage interface modules 156, to query and access other modules of the system (e.g., query processing platform 130, AI models 122A-122B, etc.), internal or external APIs, data platforms (e.g., including data stores), etc. Interface module 156 may include a database interface module. Suffice to say for now, the support module platform may be leveraged by chat module 180 to complete operations related to a user query delivered to the system.

In some embodiments, storage platform 160 may host and manage data store 160A and 160B. In some embodiments, data store 160A may be a persistent storage that is capable of storing structured data (e.g. graphs, tables, spreadsheets pertaining to e.g., vendor names, order numbers, dates, etc.) and associated metadata, while data store 160B a persistent storage that is capable of storing unstructured data (e.g., video, text, or vectorized data, etc. pertaining to documents, emails, videos, etc.) and associated metadata. In some embodiments, storage platform 160 may include a platform control module 162 (e.g. a database manager) to manage and respond to database requests.

In some embodiments, any of the modules and or platforms can host or leverage an AI model (e.g. a local AI model, e.g., AI models 122A or 122B) for performing processes associated with the respective module.

In one embodiment, such an AI model may be one or more of decision trees, random forests, support vector machines, or other types of machine learning models. In one embodiment, such an AI model may be one or more artificial neural networks (also referred to simply as a neural network). In one embodiment, processing logic performs supervised machine learning to train the neural network.

Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

As indicated above, such an AI model may be one or more generative AI models, allowing for the generation of new and original content, such a generative AI model may include aspects of a transformer architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. Further details regarding generative AI models are provided herein.

In some embodiments, such an AI model can be an AI model that has been trained on a corpus of textual data. In some embodiments, the AI model can be a model that is first pre-trained on a corpus of text to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets. In some embodiments, such an AI model may be capable of being directed via user-generated prompts. In embodiments, such an AI model may be “steered” via user-generated prompts.

In some embodiments, the AI model can then be further trained and/or fine-tuned on organizational data, including proprietary organizational data. The AI model can also be further trained and/or fine-tuned on organizational data associated with a PMSS, or PM systems at large.

In some embodiments, such an AI model may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In some embodiments, a first AI model may dynamically generate prompts for a second AI model (or other software component such as a database). For instance, with respect to data retrieval, a first AI model may leverage a database schema (e.g., a simplified view of available data that is understandable without expert domain knowledge, and including natural language descriptions) to generate a formal prompt to index and retrieve relevant subsets of tables for a given user query. In some embodiments, the AI model(s) can include a retrieval component of a retrieval-augmented generation (RAG) system for providing context associated with the request to the generative AI model.

In some embodiments, data stores 160A and 160B may be hosted by one or more storage devices, such as main memory, magnetic or optical storage-based disks, tapes or hard drives, network-attached storage (NAS), storage area network (SAN), and so forth. In some embodiments, data stores 160A and 160B may be a network-attached file server, while in other embodiments, data stores 160A and 160B may be some other type of persistent storage such as an object-oriented database, a relational database, and so forth. In some embodiments, data stores 160A and 160B may be hosted by any of the platforms or devices associated with system 100 (e.g. support module platform 150). In other embodiments, data stores 160A and 160B may be on or hosted by one or more different machines (e.g., the PMSS platform 170 and support module platform 150) coupled to the virtual meeting platform via network 101.

In some implementations, the data stores 160A and 160B may store portions of audio, video, or text data received from the client devices (e.g. client device 110) and/or any platform and any of its associated modules.

In some embodiments, any one of the associated platforms (e.g. the PMSS platform 170) may temporarily accumulate and store data until it is transferred to data stores 160A of 160B for permanent storage.

In general, functions described in embodiments as being performed by any of the system platforms, may also be performed by the client device(s) of the system. In addition, the functionality attributed to a particular component may be performed by different or multiple components operating together. Any of the system platforms or modules may also be accessed as a service provided to other systems or devices through appropriate application programming interfaces (APIs), and thus is not limited to use in websites.

It is appreciated that in some other implementations, the functions of platforms 120, 130, 150, 160, or 170 may be provided by a fewer number of machines. For example, in some implementations, functionalities of platforms 120, 130, 150, 160, and/or 170 may be integrated into a single machine, while in other implementations, functionalities of platforms 120, 130, 150, 160, and/or 170 may be integrated into multiple, or more, machines. In addition, in some implementations, only some platforms of the system may be integrated into a combined platform.

In general, functions described in implementations as being performed by platforms 120, 130, 150, 160, and/or 170 may also be performed by the client devices (e.g. client device 110). In addition, the functionality attributed to a particular component may be performed by different or multiple components operating together. Platforms 120, 130, 150, 160, or 170 may also be accessed as a service provided to other systems or devices through appropriate application programming interfaces, and thus is not limited to use in websites.

It is appreciated that in some implementations, platforms 120, 130, 150, 160, or 170, or client devices of the system (e.g. client device 110) and/or data stores 160A, 160B, may each include an associated API, or mechanism for communicating with APIs. In such a way, any of the components of system 100 may support instructions and/or communication mechanisms that may be used to communicate data requests and formats of data to and from any other component of system 100, in addition to communicating with APIs external to the system (e.g. not shown in FIG. 1).

In some embodiments of the disclosure, a “user” may be represented as a single individual. However, other implementations of the disclosure encompass a “user” being an entity controlled by a set of users and/or an automated source. For example, a set of individual users federated as a community in a social network may be considered a “user.” In another example, an automated consumer may be an automated ingestion pipeline, such as a topic channel.

FIG. 2 illustrates example support processes for responding to a user query made within the system of FIG. 1, in accordance with embodiments of the present disclosure.

As illustrated by FIG. 2, in some embodiments, a user query may flow through process 200 in order to be routed to an appropriate support module. Process 200 may include a chat module 280, an AI model 222, one or more support modules 254, an interface module 256, and a storage platform 260 and external modules 264. In some embodiments, chat module 280 may correspond, or be similar to chat module 180 as was seen and described with respect to FIG. 1, and incorporate and/or augment at least the embodiments described therein. In some embodiments, AI model 222 may correspond, or be similar to AI models 122A and/or 122B as were seen and described with respect to FIG. 1, and incorporate and/or augment at least the embodiments described therein. In some embodiments, support modules 254 may correspond or may be similar to support modules 154 as were seen and described with respect to FIG. 1, and incorporate and/or augment at least the embodiments described therein. In some embodiments, interface module 256 may correspond or may be similar to interface module 156 as was seen and described with respect to FIG. 1, and incorporate and/or augment at least the embodiments described therein. In some embodiments, storage platform 260 may correspond or may be similar to storage platform 160 as was seen and described with respect to FIG. 1, and incorporate and/or augment at least the embodiments described therein. In some embodiments, external modules 264 may be any of the modules discussed with respect to FIG. 1 (e.g., semantic analysis module 132). In some embodiments, storage platform 260 and/or external modules 264 may be external to the system described in FIG. 1.

The process may begin by receiving a user query 202A at chat module 280 (e.g., through use of a client device and an input feature, as described with respect to FIG. 1). User query 202A may be any user query from a user 202. For example, a user of the PMSS as described herein may input a textual query into the input feature of a UI that is presented to them. Such a query can include a user request 202B, and an indicated intent 202C. In some embodiments, the indicated intent and user request of the query may be explicit, suggested, or implicit. For example, a user may explicitly state, “show me all records of defaulting or delinquent tenants with respect to property units x, y, and z.” The request of such a query may be to view such records, the intent may be to access and view such records. In a more suggested, or implicit form, a similar query may be phrased, “Can you help me remember how often units x, y, and z have had delinquent or defaulting tenants?” Although the user is not explicitly requesting the records for defaulted tenants, such a request may still be recognized by the module. In such a case, the request may be to view or receive the statistics of how frequently units x, y, and z, have had delinquent tenants. The intent may still be to access the records associated with delinquent or defaulting tenants. In such a way, a query may contain both an intent, and a request.

In embodiments, a user of the system may chain together tools (e.g., one or more support modules) via a single query to accomplish one or more tasks. For instance, finding tenants at a property could be followed by a bulk action, such as sending one or more tenants a message (e.g., via email). In embodiments, such a combined task may first retrieve tenant data (e.g., email addresses), and then utilize the retrieved data to populate the recipients of the message, and personalize each message with data pertaining to their associated records (e.g. an outstanding balance).

In embodiments, such one or more tasks may be associated and/or requested implicitly via a single query. For example, a query such as: “send tenants at property X a note that elevator maintenance is scheduled tomorrow,” may implicitly include a data query (e.g., “get tenants at property X”), followed by a message compose action (“send a message that . . . ”).

One of ordinary skill in the art, having the benefit of this disclosure, will appreciate that a user query may span many requests and intents associated with a PMSS, including, but not limited to, a request to summarize a document, a request to provide instructions, a request to send a communication to a resident (e.g., an email, text, etc.), a request to draft a document (e.g., a request to draft text, format a document, etc.), a request to provide a report including data associated with the PMSS, a request to generate a marketing description, a request to present a document, a request to generate a response to one or more questions (e.g., to generate a response about product usage), a request to retrieve data (e.g., to find or build a report), a request to produce code, or any other type of request, combination or requests, and/or sequences of requests associated with a PMSS.

As will be further described with respect to FIGS. 3A-B, chat module 280 may receive, process, augment, validate, and/or route user query 202A. In some embodiments, chat module 280 may process user query 202A to recognize the query request and intent. Based on such an intent, the module may route the query as query 204A to one or more appropriate support modules. In some embodiments, support module 254 may include several specific support modules 254A-G for routing a query to. In some embodiments, a specific support module 254A-G (or more than one), may be chosen for chat module 280 to route the query to based on the exact query intent. In some embodiments, the chat module may store and/or recognize queries with similar requests and/or intents, so as to more rapidly route the query.

In some embodiments, if the request is underspecified or ambiguous the chat module may engage (with aid from AI model 222) in a conversation with the user to clarify or obtain missing information. In some embodiments, the chat module 280 may route a query to a support module, and then receive a communication from the support module that the query is underspecified or ambiguous, and proceed in a similar manner to clarify or obtain information. In embodiments this may be accomplished via a visual element of the UI (e.g., such as a chat box or search box). In some embodiments, chat module 280 and support modules 254A-G may leverage an AI model 222, to engage in such a conversation.

As mentioned above, support modules 254 may include specific support modules 254, to perform more specific, or focused support operation. A detailed description of each will be provided below. As a whole, support modules 254 (e.g., including any specific support module 254A-G) and/or chat module 280 may leverage interface modules 256, including data interface manager (DIM) 256A, and one or more API modules (e.g., API module 256B) for accessing and retrieving data associated with a storage platform 260 and database (e.g., a data store), or accessing and performing support operation (e.g., tasks) associated with modules external (or internal) to the system (e.g., external modules 264).

In some embodiments, for example, a support module may leverage API module 256B, which may index and present available APIs, including natural language descriptions of their scope, parameters, and response format, to generate a properly structured API request. In some embodiments, support modules may leverage the interface modules 256 and the AI model 222 to create such a communication. Such a process will be further described with respect to FIG. 3B, suffice to say now, that API module 256B and DIM 256A may be used by any support module to generate a structured API request that can be directly consumed by external (or internal) software systems and/or modules to perform a task. In some embodiments, a support module may generate the API communication and present it to the user for confirmation or modification. In other embodiments, a support module may directly execute the API communication sans user confirmation. As will be further discussed with respect to FIG. 3B, DIM 256A may function in a similar manner to form a structured communication for a storage platform or database.

A short description of the support modules 254A-G will now be provided. One of ordinary skill in the art, having the benefit of this disclosure, will appreciate that such a list of support modules is not exhaustive, and that in certain embodiments, further support modules may be incorporated within support modules 254.

In some embodiments, the support modules may include a text2data support module 254C. In some embodiments, text2data support module 254C may receive a routed query from chat module 280 when the chat module has determined that the query intent is to access a database. In embodiments, the text2data support module may be capable of mapping a natural language query into a formal query language. This can be useful for requests e.g., such as “show me tenants at property X with outstanding balance of more than $500.” Such a process will be further described with respect to FIG. 3B.

In some embodiments, the support modules may include a text generation support module 254A. In some embodiments, text generation support module 254A may receive a routed query from chat module 280 when the chat module has determined that the query intent is to generate text from a user prompt within the query. Such instances may include when chat module 280 has identified that a request intends to create a draft email, a draft passage of text, or a draft summary of a document, etc. In some embodiments, the text generation support module 254A may leverage the AI model 222, which may be a generative AI model such as an LLM or similar, to generate natural language text for a user. In some embodiments, the text generation support module 254A may generate text including provided data. For instance, in some embodiments, the text generation support module 254A may generate text having pre-filled recipients from a previous data query, or generate text containing placeholders to personalize messages (including data fields, such as an outstanding balance). In some embodiments the text generation support module 254A may generate text that has been translated from a first language to as second language (e.g., into the recipients' preferred language(s)). In some embodiments, the text generation support module 254A may send messages via recipients preferred communication method (email, SMS, WhatsApp, etc.). In some embodiments the sending of a communication may be accomplished via the text2Action module 254D, or via an external module.

In some embodiments, the support modules may include a marketing description support module 254B. In some embodiments, marketing description support module 254B may receive a routed query from chat module 280 when chat module has determined that the query intent is to create a marketing description for a particular property, or similar element (e.g., a home or rental unit). In furtherance of such an objective, module 254B may access data and characteristics associated with an identified property stored within the system, such that a user may not have to input all such information associated with a property. Such information can include, by way of example, square footage, location, amenities, property characteristics, etc. In some embodiments, module 254B may provide such information, along with the user query and other information, to AI model 222, which may be a generative model, to arrange, format, and expand on the information to create a proper response to the user query.

In some embodiments, the support modules may include a text2action support module 254D. In some embodiments, text2action support module 254D may receive a routed query from chat module 380 when the chat module has determined that the query intent is to perform an action associated with a PMSS. Such actions can include, sending an email, preparing a contract, assigning a vendor to a work order, adding a note or reminder to a work order, marking a work order as complete or incomplete, etc. In such cases, the smart action module 254D may leverage API module 256B, and AI model 222 (which may be an LLM) to interpret whether such an action is feasible given the available APIs. In some embodiments, if such an action is feasible, module 254D may form and format the API communication, and transmit it to a corresponding software module and/or database. In other embodiments, module 254D may be outfitted to accomplish the requested action independently.

In some embodiments, the support modules may include a report filtering support module 254E. In some embodiments, report filtering support module 254E may receive a routed query from chat module 280 when chat module has determined that the query intent is to request a type of report. In some embodiments, support module 254E may form a database query to gather data for the report, by leveraging DIM 256A, the AI model, and the user query. Support module 254E may then execute the database query, and access and retrieve the specified data (e.g., from storage platform 260 and any associated databases) necessary to create a report. For example, should module 280 identify that the user query would like to access “x” data, module 254E may communicate with DIM 256A to form a formal database query for accessing “x” data from the corresponding datastore and/or storage platform. Module 254E may then execute the query (or cause DIM 256A to execute that query) against a database. After such, module 254E may perform more processing on the data (e.g. in some cases leveraging modules of query processing platform, in some cases leveraging models of the AI model platform) to manipulate the data into an acceptable format for transmitting the data indicated by the user query back to chat module 280.

In some embodiments, a requested report may be prebuilt, and simply retrieved via the report filtering support module 254E (or a separate support module). In some embodiments, the report filtering support module 254E may modify, or “prune,” a prebuilt report that has been retrieved. E.g., report filtering support module 254E may apply filters, include specific columns, etc.

In some embodiments, the support modules may include a QA bot support module 254F. In some embodiments, QA bot support module 254F may receive a routed query from chat module 280 when the chat module has determined that the query intent is to receive an answer to a question associated with operating the PMSS. In some embodiments, this is accomplished by providing resources, such as product specific help articles and documentation, either as context with instructions or via another fine-tuning step involving known question and answer pairs. In some embodiments, these are then turned into a natural language summary of the required steps (via aid of the AI model 222), and include citations of specific sources based on the provided context such that a user can verify the information. In some embodiments, module 254F may perform the final formatting of the response to the user, in others, module 254F may simply provide the information to chat module 280, which may then accomplish the final formatting. In some embodiments, the chat module 280 may directly route a user to a relevant page, or offer to execute an action on behalf of the user, rather than simply provide information or summaries.

In some embodiments, the support modules may include a human support module 254G. In some embodiments, human support module 254G may receive a routed query from chat module 280 when the chat module has determined that the query intent is such that it cannot be processed by any other support module of the system. In some embodiments, such a query may be delivered into a queue, to await a human response. In some embodiments, the module may facilitate a human response, such as a text (e.g., an instruction, clarifying question, etc.).

In some embodiments, any of the above support modules can return a response 204D after an operation has been executed by the support module. As discussed above, in some embodiments, the response may be a confirmation that an action has been completed, a request for more information, data retrieved from a database, or a textual response to the user query. In some embodiments, as previously mentioned, the chat module 280 may divide a user query into one or more subqueries to multiple tools (e.g., support modules of support modules 254), and combine the results.

Thus, in some embodiments, support modules 254 may include several support modules 254A-G, for performing support tasks associated with a user query.

FIG. 3A illustrates an example process for routing a user query made within the system of FIG. 1 to a support module, in accordance with embodiments of the present disclosure.

Process 300A of FIG. 3A may include an input feature 316 of a client device, a user query 302A, a semantic analysis module 332, a validation module 334, a chat module 380, one or more support modules 354 and interface modules 356, of a support platform 350, a filtering module 336, and one or more AI model(s) 322. In some embodiments, input feature 316 may correspond, or may be similar, to input feature 116 as was seen and described with respect to FIG. 1 and incorporate and/or augment at least the embodiments described therein. In some embodiments, user query 302A may correspond, or may be similar, to user query 202A as was seen and described with respect to FIG. 2 and incorporate and/or augment at least the embodiments described therein. In some embodiments, semantic analysis module 332 may correspond, or may be similar, to semantic analysis module 132 as was seen and described with respect to FIG. 1 and incorporate and/or augment at least the embodiments described therein. In some embodiments, validation module 334 may correspond, or may be similar, to validation module 134 as was seen and described with respect to FIG. 1 and incorporate and/or augment at least the embodiments described therein. In some embodiments, support modules 354 may correspond, or may be similar, to support modules 154 and/or 254 as were seen and described with respect to FIGS. 1-2 and incorporate and/or augment at least the embodiments described therein. In some embodiments, interface module 356 may correspond, or may be similar, to interface modules 156 and/or 256 as were seen and described with respect to FIGS. 1-2 and incorporate and/or augment at least the embodiments described therein. In some embodiments, support platform 350 may correspond, or may be similar, to support platform 150 as was seen and described with respect to FIG. 1 and incorporate and/or augment at least the embodiments described therein. In some embodiments, filtering module 336 may correspond, or may be similar, to filtering module 136 as was seen and described with respect to FIG. 1 and incorporate and/or augment at least the embodiments described therein. In some embodiments, AI model 322 may correspond, or may be similar, to AI model 122A, 122B, and/or 222 as were seen and described with respect to FIGS. 1-2 and incorporate and/or augment at least the embodiments described therein. In some embodiments, chat module 380 may correspond, or may be similar, to chat modules 180 and/or 280 as were seen and described with respect to FIGS. 1-2 and incorporate and/or augment at least the embodiments described therein.

As illustrated by FIG. 3A, in some embodiments, the flow of a query through process 300 for processing a user query may begin at operation 3.1 (i.e. query collection 3.1). At operation 3.1, process 300 may receive a user query 302A through an input feature 316 of the system.

Input feature 316 (which may correspond to input feature 116 of FIG. 1) may be any feature capable of intaking text data from a user, including, but not limited to, a chat box, a query feature, a chat box including speech to text capabilities, etc. In embodiments, the input feature may accept any form or type of input data relevant to a PMSS, including audio, image, video, text data, etc. E.g., in embodiments, a user may upload an image such as an image of an invoice to be processed and responded to by the system. One of ordinary skill in the art, having the benefit of this disclosure, will be able to implement different versions of input feature 316, while still maintaining the functionality of transferring a user query from a client device to a PMSS platform.

In some embodiments (as was described with respect to query 202A in FIG. 2), a user query 302A may be a natural language user request for an action or data. E.g., a user query may be, a request for an explanation, a request for a report, or any natural language prompt associated with PMSS.

In some embodiments, following collection 3.1, the process 300 may route a user query at operation 3.2, by performing semantic analysis 3.2A and validation 3.2B. In some embodiments, a chat module 380 of the system may leverage, direct, or otherwise cause routing 3.2 to be performed. In some embodiments, such a chat module may distribute the user query 302A to semantic analysis module 332, and collect the routed query 304A from validation module 334. In other embodiments, the chat module itself may form the functions of operation 3.2. In some embodiments, validation 3.2B may precede semantic analysis 3.2A, or occur in parallel.

In some embodiments, semantic analysis module 332 may perform semantic analysis to interpret a user query, identify its associated request and intention. In some embodiments, semantic analysis module 332 may leverage a LLM associated with the system (e.g., any of the AI models and/or LLMs described with respect to current disclosure) to aid in performing semantic analysis.

In some embodiments, the semantic analysis module may preprocess the user query using a variety of known NLP methods and techniques so as to extract the intention and request associated with a query. Such methods and techniques may include, tokenization, part-of-speech tagging, categorization according to semantic structure, and/or named entity recognition (NER) (e.g. to extract names, organizations, locations, and other categorical information), and other such or similar techniques. In some embodiments, semantic analysis module 332 may perform NER, in other embodiments, semantic analysis module 332 may leverage a dedicated NER software platform or service.

Entity recognition (e.g. NER) may be performed by module 332 to extract entities, e.g., a term associated with text, such as an object, place, or concept, etc., from a user query. To begin with, entity recognition may tokenize the query, thereby segmenting the query into tokens representing individual words, or similar structures within the query. Following tokenization, the entity recognition module can perform part-of-speech tagging, via its semantic role (e.g. identifying each token as a noun, verb, adjective, etc.).

After such processes, the semantic analysis module may apply entity extraction. This step may use the tagging and a NER subsystem of the semantic analysis module such as a trained machine learning model, to identify which tokens or groups of tokens constitute potential, or candidate, entities.

In some embodiments, the NER subsystem can be, or use, one or more of a dictionary-based approach, a rules-based approach, a machine learning approach, a transfer learning approach (such as fine-tuning an off-the-shelf LLM for NER), or a LLM (e.g., an LLM based on transformer architecture, such as bidirectional encoder representations from transformers (BERT), ROBERTa, or the GPT series of LLMs, etc.), or any combination of such algorithms.

After candidate entities have been extracted from the user query and categorized via the above processes, such candidate entities can be verified via a search engine. For example, in some embodiments, the candidate entities are used as search queries for the search engine where the search is narrowed via the entity category. Retrieval of relevant and logical results may corroborate their status as actual entities, as well as correct typos, resolve ambiguities, or return an internal identifier of the entity that can be used to filter queries in the text2data module. Such results may also aid in rendering a search field for the user to resolve ambiguities (e.g., in the simple case where multiple tenants share a same name, the results may be provided to a user to select the target tenant). Such a process may involve searching for the potential entity in the title, abstract, or body of the returned search results. In the absence of such corroborative information, a candidate entity might be flagged for further investigation, or classified as a non-entity based on certain thresholds or criteria. Semantic analysis module 332 may include a search engine, or may query an external, existing one.

Thus, entities associated with a user query, and processes such as entity recognition (NER), may be performed by the semantic analysis module 332. Such a process may be in furtherance of recognizing the intent, request, and/or meaning behind such a user query. After such a process, semantic analysis module 332 may transfer the produced semantic analysis data (e.g., entities, intent, request, etc.), back to chat module 380, or otherwise directly transfer the data as augmented query 302D to validation module 334.

One of ordinary skill in the art, having the benefit of this disclosure, will appreciate that NER and entity extraction in general is a rapidly developing field of natural language process (NLP), and appreciate that the above list of NLP algorithms and techniques is non-exhaustive. Such a list may be updated to include further NLP algorithms for performing NER.

One of ordinary skill in the art, will recognize that there are many methods (NLP-associated and otherwise) that may be used to interpret the intention and request of a natural language user request, and that the above list of methods and techniques is non-exhaustive. One of ordinary skill in the art, will appreciate that such an area of NLP is a rapidly developing area of research, and that the above list may updated and expanded to include further NLP methods and techniques as they become available.

Once the intent and request associated with a query have been recognized and understood, the chat module may determine which support module of modules 354 to route the query to. Chat module 380 may use the intent, request, and extracted semantics data, together with a routing approach such as rules-based approach such as key-word matching, a neural network classifier, a LLM, or any other common query routing technique to determine a destination support module to which to route a user query.

In some embodiments, if insufficient information is available within the query to identify an intent and request, chat module 380 may leverage a LLM to generate a response requesting further information. In such a way, the process can be repeated until a user intent and request can be identified.

In some embodiments, the query can be augmented by the chat module 380 (or by the semantic analysis module) with the extracted semantics data, or with any other kind of data relevant to the query, meaning that additional information (e.g., such as an identified query intent and request) can be attached to the query as it is transmitted for further processing. In such a way, entity recognition and semantic processing need not be performed again, or duplicated by downstream processes. In some embodiments, the query may be augmented with any data available to the chat module 380 (or any data available to the system at large), such as user specific data, including contextual information regarding the page the user is currently visiting.

In some embodiments, before and/or after the query has been analyzed, the query may be compared against one or more previously processed queries. In embodiments, comparing against previously processed queries may aid in analysis and routing. E.g., a query may be processed to identify a level of similarity with a previously made query, and may be similarly routed. Such a process may enhance routing, speed up processing, and decrease computational time and resource-usage.

In some embodiments, at operation 3.2B, the process may validate an augmented query 302D from chat module 380. Validation module 334, may effect processes that ensure the integrity and appropriateness of a user query before further processing.

For example, at operation 3.2B, module 334 may conduct several verification processes of the user query, including, but not limited to verification processes associated with syntactic correctness (e.g., in format, structure, length, punctuation, completeness, etc.) permissions verification (e.g. verifying a user's role, access level, etc. to view or access data indicated by the request), content monitoring (e.g., screening for phrases, words, or patterns that may be inappropriate, offensive, or in violation of guidelines, rules, and/or policies of the PMSS), etc.

Such validation processes may include, but are not limited to, similar processing techniques as described in operation 3.2A (and may leverage the attached semantic data of the augmented query) including, but not limited to, filtering techniques, tokenization, tokenization, part-of-speech tagging, categorization according to semantic structure, NER, keyword matching, or comparison to keyword lists, etc. One of ordinary skill in the art will appreciate that many similar methods may be included, and that the above list is non-exhaustive.

By executing such verification processes, the validation module 334 ensures that query 302D is valid, appropriate, and compliant with the system's rules and guidelines prior to further processing. As was described above, such a validation process may be conducted prior, in tandem with, or after semantic analysis, and intent recognition from semantic analysis module 332.

In some embodiments, validation module 334 may pause the process and routing of the query, if such a query is deemed to be invalid, surpass the user's access permissions, or otherwise violate a policy of the system.

As mentioned above, in addition to validating, the validation module may further augment query 302D (e.g., such that routed query 304A is augmented with additional data). In such a way, chat module 380 and/or validation module 334 may attach semantic, validation, or other useful data to the user query. Such data can be of the form of entity identifiers, types, and metadata of extracted entities. Such data can serve to provide deeper contextual insights into the query, request, and intent that may be useful in downstream processes. For instance, if an extracted entity is a known person, such data might be attached to the query, along with identifiers like occupation, geographical location, or any other relevant metadata associated with the extracted entity. Such data can be used by downstream processes (e.g., support modules 354).

In addition to routing, semantic analysis, and validation, chat module 380 and/or validation module 334 may also anonymize the query. The anonymization process typically involves identifying and obscuring or replacing personally identifiable information (PII) within the query. For example, PII might have been identified during semantic analysis, and may include names, addresses, contact information, or any other information that could potentially identify an individual. Using anonymization algorithms, chat module 380 and/or validation module 334 may detect such information, and replace it with anonymized tokens or entirely remove it from the query, while leaving the overall content and intent unaltered.

Thus, through a combination of semantic analysis that may include LLM integration, and/or entity recognition techniques, chat module 380 may generate, or direct to be generated, a representation of the query's intent and request. Based on such a representation, a decision may be made regarding the most suitable routing path for the query. As was discussed above, in some embodiments, such a decision for routing may be made based on a series of predefined rules or algorithms (e.g., a rules-based algorithm using keyword matching). In some instances, other sorts of decision-making algorithms (which may include the use of machine-learning models including large language models, deep learning models, neural networks, convolutional neural networks, etc.) may be used to identify the most relevant destination for the query.

At the outset of the above processes, a validated query (e.g., routed query 304A, which is augmented and validated) may be routed to a support module of support modules 354 of platform 350 (as were discussed with respect to modules 254 and platform 250 of FIG. 2). As was described above, such support modules may complete a support operation or task and/or provide a response, gather data that will enable module 380 to generate a response, or otherwise facilitate operations associated with the routed query. Such support operations and processes (e.g., support operations 3.3 and 3.4) were discussed with respect to FIG. 2, and will be further discussed with respect to FIG. 3B. Suffice to say now, in many such support operations, a database may need to be accessed by the support module platform, or an external (or internal) API may need to be invoked.

After such processes are performed, in some embodiments, the support modules and support platform may output a communication (e.g., in the form of executed query 304D) that may be returned to chat module 380, which may then leverage a filtering module and an AI model for filtering and response generation (at operation 3.5). In other embodiments, the support platform 350 may transfer executed query 304D directly to filtering module for filtering.

In some embodiments, executed query 304D may be the same query as routed query, with further augmentations e.g., such as further augmentations that include data retrieved from a database. In other embodiments, the query may be augmented with an indication that a request within the query has been executed, or a similar augmentation.

Prior to transmission of the user query, and any attached data, to the AI model 322, and back to a user, a filtering model 336, may perform filtering of the query and its augmentations to ensure appropriateness and formatting as required by an AI model 322 for response generation (e.g., at operation 3.5A).

By way of example, in some embodiments, inputs to the AI model 322 may have a maximum length constraint, and in some cases, executed query 304D, together with any augmentations from processing may surpass such a maximum length constraint. In such cases, filtering may shorten an executed query to produce a filtered query, prior to processing by AI model 322.

After filtering, the AI model 322 may form a response to the user query to send to the user (at operation 3.5B), based on executed query and any augmentations that such a query may have.

For example, in some embodiments, if a query (including a request and intent) has requested a report on data from a database associated with the PMSS, executed query 304D may be augmented with such report data from processes 3.3 and/or 3.4. AI 322 may then receive both the query, and query augmentations, and format a response to the query in natural language. In more specific examples, a user of the PMSS may provide a query requesting a report of all the expenses associated with a business unit, or rental unit associated with a RE owner, or a user query may request guidance or instructions for example on the sequence of tasks necessary to provide an eviction notice to a renter of a rental unit. In both such cases, the PMSS may need to access a database, and stored records, or instructional documentation to provide an adequate response. Such records and documentation may be similarly attached to the query as augmentation data by processes 3.3 and/or 3.4, and transmitted to AI model 322 at operation 3.5B.

In some embodiments, the AI model 322 may correlate the query (including semantic data) and augmentation data, and align the semantics of the query with the context provided by the data. This may involve mapping the entities, actions, or conditions identified in the user query to corresponding elements (e.g., column names, data types, records, etc.) within the augmentation data. Based on such correlational understanding, the AI model may generate a response to the user query. In some embodiments, such a response could be a factual answer, a summary of relevant data, or a more complex analysis or prediction based on the data. Such a response may then be formulated in natural language, making it easily comprehensible to the user.

Thus, AI model 322 may process, understand, and respond to the user query within the context of the retrieved data, and thus provide useful responses based on such data. Thus, in some embodiments, the retrieved data, attached to the query as an augmentation, may be sourced from the storage platform may provide the content or context for answering or addressing the user query.

In some embodiments, the AI model 322 may form a response 302E to the user query 302A, where no data retrieval has been performed, or only a task, or support operation has been performed. In such cases, executed query 304D may or may not be augmented with retrieved data, but may be augmented with a confirmation that such a task (e.g., a support operation) has been performed. The AI model 322 may similarly generate a response to the user query, leveraging known data and prior training, and the confirmation found in the query augmentation.

FIG. 3B illustrates an example process for performing support operations within the system of FIG. 1, in accordance with embodiments of the present disclosure. The elements, numberings, and descriptions of FIG. 3A are incorporated herein.

In some embodiments, process 300B of FIG. 3B further include a DIM 356A, a storage platform 360, and API module 356B, and an external module 364. In some embodiments, DIM 356A may correspond, or may be similar, to DIM 256A as was seen and described with respect to FIG. 2 and incorporate and/or augment at least the embodiments described therein. In some embodiments, API module 356B may correspond, or may be similar, to API module 256B as was seen and described with respect to FIG. 2 and incorporate and/or augment at least the embodiments described therein. In some embodiments, DIM 356A and API module 356B may be a part of interface module 356, as was similarly seen with DIM 256A, API module 256B and interface module 256 with respect to FIG. 2. In some embodiments, storage platform 360 may correspond, or may be similar, to storage platform 160 and/or 260, as were seen and described with respect to FIG. 1-2 and incorporate and/or augment at least the embodiments described therein. In some embodiments, external module 364 may correspond, or may be similar, to external module 264, as was seen and described with respect to FIG. 2 and incorporate and/or augment at least the embodiments described therein.

In some embodiments, the support modules 354 may leverage interface modules 356 to perform support operations (tasks) based on a routed query 304A, and output an executed query 304D (as were described in FIG. 3A).

In some embodiments, a query may include a request that requires data retrieval (operation 3.3) from a database. To properly retrieve data from a database (e.g., such as a database within data stores 160A or 160B of FIG. 1) the support module platform, or DIM 356A, may need to perform database mapping (seen at operation 3.3A), query formalizing (seen at operation 3.3B) and data retrieval (seen at operation 3.3C). In some embodiments, such operations can be facilitated and/or performed by support modules 354 and/or DIM 356A. In some embodiments, more than one data retrieval may need to be accomplished for a routed query, by one or more support modules.

In some embodiments, database mapping 3.3 can intake a routed user query (e.g. routed query 304A) and attached augmentation data 304B (e.g. semantic and/or validation data) that has been attached or augmented to the user query. Such a process may produce mappings 306B, or database structures that correspond to the entities and structures identified within the user query. Thus, in some embodiments, it is assumed that entity recognition and query augmenting (including all embodiments and details described in FIG. 3A) may have already been fully accomplished, and that routed query 304A includes augmentation data.

Accordingly, the DIM may leverage a database schema 306A, together with the query and entity data to produce mappings, or corresponding database entities associated with a database. In some embodiments, DIM 356A may produce mappings 306B by cross-referencing query and entity information with the database schema 306A.

In some embodiments, such a schema 306A can act as a map, or look-up table, corresponding to the database, outlining its organization and content. Such a schema may include details of the structure of the database, including table names, table definitions, field types, column names, relationships, indices, keys, and any constraints, etc. associated with an associated database.

DIM 356A may therefore align the semantics of the user query with the specific language and structure of the database. For example, if a query specifies a database request along the lines of “show me the names and ages of all renters who are late on rent for the current month,” the extracted entities may include “renters, delinquency status (and/or period), date range.” DIM 356A might intake such a query and augmentation (e.g., entity) data, and identify corresponding data fields such as “renters.first_name, renters.last_name, renters.age, renters.delinquency_status . . . ,” and so on. Such mappings can be output as mappings 306B, or otherwise be attached to the query, as further augmenting or augmentation data.

The DIM can then leverage an AI model 322 to formalize the query, and retrieve data from a data store, as seen in operation 3.3C by executing the formal query against a database and/or associated storage platform. As previously mentioned, in some embodiments, the mappings or the formal query can be stored, together with the user query and any query augmentation data to facilitate rapid processing for similar user queries that may be received in the future.

In some embodiments, the AI model 322 can intake the user query (e.g. routed query 304A) and mappings 306B, and formalizes the query, i.e., create a structured query in the appropriate language, that adheres to the syntax and conventions of the database associated with the database schema. In other words, AI model 322 may translate the query from natural language to the database language. The result is a formalized user query (e.g., formal query 304C) that is ready to be run against the target database.

At operation 3.3C, the DIM (or an associated support module) can then transfer the query to the appropriate database, and receive the requested data 306C. The transmission of a formal user query to a storage platform 360 and associated data stores and databases, to retrieve data 306C may be facilitated by a database control module (e.g. that may be similar, analogous, or part of platform control module 162 as seen in FIG. 1) equipped to receive the query and perform data extraction. In embodiments, the storage platform 360 may further authenticate and authorize a requesting user to ensure that the user is authorized to access queried data.

Such processes may involve technologies such as JDBC for Java platforms or ODBC for lower level programming languages like C or C++. These protocols provide a standardized API for database queries and operations, and ensure secure and reliable data transmission between the DIM and the storage platform 360. Once a connection is established, the DIM may transfer the formal query 304C to the storage platform 360. The storage platform may then execute the query against the database (e.g. a datastore), to retrieve the requested data. This retrieved data 306C could be in various forms, including vectorized, structured, or unstructured data, depending upon the nature of the query and the database schema. The storage platform 360 may then send the retrieved data back to the DIM over the established connection.

Finally, the DIM returns the received data back to support modules 354, which may further process the data, perform operations based on the data, or prepare a response for the user based on the data. In some embodiments, the received data 306C, can then be attached (through augmentation, in a similar method as described with respect to the entity data), or otherwise coupled with executed query 304D, and be sent to an AI module 322, and response generation at operation 3.5.

In some embodiments, operation execution 3.4 can proceed in a very similar manner, using similar or analogous modules to data retrieval 3.3, to execute a support operation or task (as was described with respect to FIG. 2). In some embodiments, more than one support operation may be completed. In some embodiments, the support operation may be accomplished before, after, or in tandem with, one or more data retrieval operations.

Such support operations, such as sending an email, or requesting a payment, as were discussed in FIG. 2, may need to be performed by external (or internal) modules. Thus, at operation 3.4, API module 356B can intake a routed user query (e.g. routed query 304A) and attached augmentation data 304B (e.g. semantic and/or validation data) that has been attached or augmented to the user query and may produce mappings 308B, or API structures that correspond to the entities and structures identified within the user query, that will be used to construct a communication to an API to accomplish a support operation.

Accordingly, the API module 356B may leverage an API schema 308A, together with the query and augmentation data to produce mappings, or corresponding API entities associated with an external module. In some embodiments, module 356B may produce mappings 308B by cross-referencing query and entity information with the API schema 308A.

In some embodiments, such a schema 308A can act as a map, or look-up table, corresponding to an external module API, outlining its organization and content. Such a schema may include details of the structure of the API, including possible operations, necessary fields and types, as well as expected outputs or any constraints, etc. associated with an external module. Many such API schemas can be housed within API module 356B, and interface module 356 in general.

Module 356B may therefore align the semantics of the user query with the specific language and structure of the API and capabilities of the external module. For example, if a query specifies a request along the lines of “send the following text X to email address Y,” the extracted entities may include “email address, message content, send.” Module 356B might intake such a query and augmentation (e.g., entity) data, and identify corresponding data fields such as “address.send, message.content., and task.send . . . ,” and so on. Such mappings can be output as mappings 308B, or otherwise be attached to the query, as further augmenting or augmentation data.

The system can then leverage an AI model 322 to formalize the query into an API call in a similar way that was described above with respect to operation 3.3B. Such an API call may accomplish a requested operation, and executes the formal query 304C (e.g., an API call) against an external module 364. Confirmation that an operation or task has been completed, together with any returned, or necessary data, can be returned to support modules 354 as confirmation 308C, and may be attached as augmentation data to executed query 304D.

Such processes may be similar to processes described with respect to data retrieval 3.3, and involve technologies such as JDBC for Java platforms or ODBC for lower level programming languages like C or C++. These protocols provide a standardized API for database queries and operations, and ensure secure and reliable data transmission between the interface module 356B and external module(s) 364.

Thus, the chat module 380, support modules 354, and the PMSS at large may analyze, validate, augment, execute, retrieve data associated with, perform support operations for, and generate responses to queries from a user of the PMSS.

FIG. 4 illustrates an example user interface (UI) for the system of FIG. 1, in accordance with some embodiments of the present disclosure. In some embodiments, UI 400 of FIG. 4 may be provided to, and/or for presentation, at a client device (e.g., client device 110 of FIG. 1). As described with respect to FIG. 1, UI control module 174 may generate a UI such as UI 400 to enable users to input and receive data, instructions, queries, or any other kind of communication to or from any platform or module of the system. In some embodiments, UI 400 can correspond, or may be similar, to UI 112 as was described with respect to FIG. 1, and incorporate and/or augment at least the embodiments discussed therein. In some embodiments, UI 400 can include an input feature 416. Input feature 416 can correspond, or may be similar, to input feature 116 as was described with respect to FIG. 1 and incorporate and/or augment at least the embodiments discussed therein.

As illustrated in FIG. 4, UI 400 can include one or more visual elements. As was discussed with respect to FIG. 1, a visual element may refer to a UI element that occupies a particular region in the UI. A UI can include a number of visual elements to display to a user and/or for user interaction. Such visual elements can include one or more windows (e.g. informational display windows which may display the documents, text, figures, or data streams associated with the PMSS), chat boxes (e.g. chat boxes for a user to input textual information), informational displays (such as participant lists, document viewers, etc.), as well as input elements (such as buttons, sliders, chat interfaces, spaces for text, audio, image, video, and other document uploads, etc. for a user to input data), or any other kind of visual element commonly associated with a UI.

Such visual elements can be arranged or divided into specific regions of the UI. For example, UI 400 can include a main region (e.g. main region 402) that is intended to be an area of focus of the UI. In some embodiments, such a region can include information, graphs, data, etc. for display for a user. Multiple subregions can hold other elements, such as further information, or program controls that may be displayed in subregion 404 below the main region 402 or subregion 420 which may include a chat feature associated with the PMSS. Thus, an example UI of the system can hold multiple regions.

The UI may also present to the user interactive elements like buttons and sliders for controlling various aspects of the display and/or UI elements. For instance, in some embodiments, subregion 404 may include multiple buttons for inputting commands to the PMSS for navigating, controlling a document viewer, uploading and downloading content, etc.

Via the UI, users may be shown a chat feature (e.g. seen in subregion 420) that may include a chat history of the user, either chatting with other users of the PMSS, or with the chat module (and further associated modules) of the PMSS. As seen in example UI 400, a chat history, including multiple comments 422A-D, may be displayed to a user of the system. As can be seen by link 424, the chat history can include accessible documents, data, and links that may be presented to a user of the system. Such a chat feature may be the primary point of interface with the chat module (and further associated modules) of the PMSS.

In some embodiments, input feature 416 can be used to input textual data (e.g. a user query) meant for an associated chat module (as was described with respect to FIGS. 1-3, and incorporating at least the embodiments described therein). In other embodiments, input feature 416 may include use of a microphone and a speech-to-text module, or of a machine generated textual suggestion for a user to select, or any other kind of user input that might be used for providing a query to the underlying chat module (e.g., such as a text, image, audio, and/or video upload function). Thus, a user engaging with the UI 400 can engage the underlying, chat module, AI models, and support module modules by providing a user query to the PMSS via input feature 416.

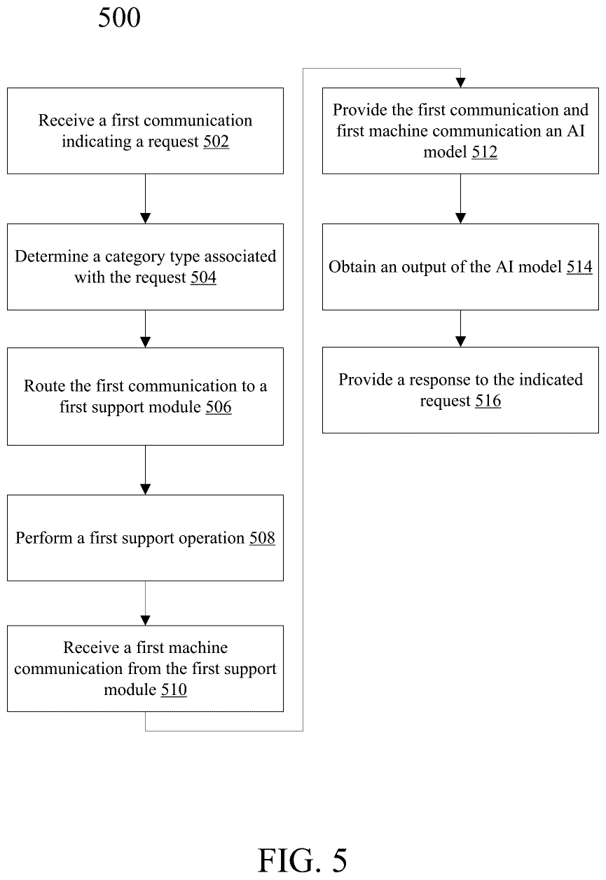

FIG. 5 illustrates a flow diagram of an example method for PMSSs users to interface with the PMSSs system, in accordance with some embodiments of the present disclosure.

Method 500 can be performed by processing logic that can include hardware (circuitry, dedicated logic, etc.), software (e.g., instructions run on a processing device), or a combination thereof. In one implementation, some, or all of the operations of method 500 can be performed by one or more components of system 100 of FIG. 1.

At block 502, processing logic can receive a first communication indicating a request.

Processing logic can receive the first communication from a client device connected to a property management software system (PMSS). The first communication may indicate a request pertaining to a PMSS.

At block 504, processing logic can determine a category type associated with the request. Processing logic can determine the category type associated with the request by performing semantic analysis to generate semantic data indicative of a category type of the request. Performing semantic analysis to generate semantic data can include extracting natural language entity data from the first communication. Determining a category type associated with the request may also include determining an intention of the request based on the extracted entity data, and matching the intention with a category type based on keyword matching based on a set of previously established keyword pairings, or matching the intention with a category type based on the output of a classifier neural network. In some embodiments, the request can be at least one of a request to summarize a document, a request to provide instructions, a request to send a communication to a resident, a request to draft a document, a request to provide a report comprising data associated with the PMSS, a request to generate a marketing description, a request to present a document, or a request to generate a response to one or more questions.

At block 506, processing logic can route the first communication to a first support module. The first support module may be capable of performing support operations associated with the category type of the request. The first support module can be one of several support modules associated with several request category types. Each support module of the several support modules may be capable of performing support operations associated with one or more category types of the several category types.

At block 508, processing logic can perform a first support operation. In some embodiments, processing logic of the first support module can perform the first support operation, which can be associated with the request. The first support operation may include at least one of retrieving data from a database, or invoking an external (or internal) API. Retrieving data from a database may include at least one of retrieving one or more documents from an unstructured database associated with the PMSS, or retrieving structured data from a structured database associated with the PMSS. Retrieving data from a database can include mapping the request to a database query via a previously generated database schema. Invoking an external API may include mapping the request to one or more external (or internal) API calls via a previously generated external API schema.

At block 510, processing logic can receive a first machine communication from the first support module. In some embodiments, the chat module may receive the first machine communication from the first support module. The first machine communication may be associated with an output of the first support operation. The first machine communication can be at least one of a response to one or more questions, data retrieved from a database, a follow-up question related to the request, or a confirmation that the one or more support operations have been performed.

At block 512, processing logic can provide the first communication and first machine communication of an AI model. In some embodiments, the chat module may provide the first communication and first machine communication as an input to a generative AI model. The generative AI model may be trained on a corpus of text to create a foundation model. The generative AI model may be fine-tuned on proprietary organizational data associated with property management. The generative AI model may be fine-tuned for application to PMSSs. At block 514, processing logic can obtain an output of the AI model.

At block 516, processing logic can provide a response to the indicated request. In some embodiments, the output of the generative AI model may be used to provide a response to the indicated request through a user interface (UI) of the client device. The response to the indicated request may be at least one of a response to one or more questions, a follow-up question related to the request, or a confirmation that the one or more support operations have been performed.

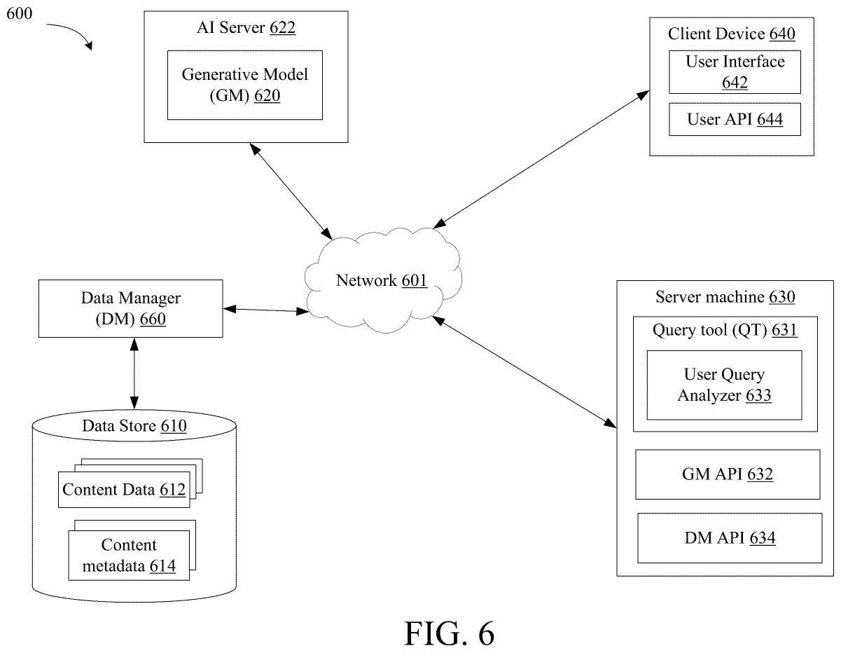

FIG. 6 illustrates a high-level component diagram of an example system architecture 600 for a generative machine learning model, in accordance with one or more aspects of the disclosure. The system architecture 600 (also referred to as “system” herein) includes a data store 610, a generative model 620 provided by AI server 622, a server machine 630 with a query tool (QT) 631, one or more client devices 640, and/or other components connected to a network 601.

In some embodiments, client devices 640 may be similar, or correspond, to client devices (e.g., device 110) of FIG. 1, and incorporate and/or augment at least the embodiments described therein. In some embodiments, client devices 640, and user interface 642, may be similar, or correspond, to client devices (e.g., device 110) and user interface 112 of FIG. 1, and incorporate and/or augment at least the embodiments described therein. In some embodiments, network 601 may be similar, or correspond, to network 101 of FIG. 1, and incorporate and/or augment at least the embodiments described therein. In some embodiments, AI server 622 and generative model 620 may be similar, or correspond, to AI model platform 120 and AI model 122A and/or 122B of FIG. 1, and incorporate and/or augment at least the embodiments described therein. In some embodiments, server machine 630, may be similar, or correspond, to PMSS platform 170 of FIG. 1, and incorporate and/or augment at least the embodiments described therein. In some embodiments, data store 610, may be similar, or correspond, to data store 160A, 160B, or platform 160 of FIG. 1, and incorporate and/or augment at least the embodiments described therein.

In some embodiments, network 601 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), and/or the like. In some embodiments, network 601 may include routers, hubs, switches, server computers, and/or a combination thereof.

In some embodiments, any of AI server 622, server machine 630, data store 610 and/or client device(s) 640 may include a desktop computer, a laptop computer, a smartphone, a tablet computer, a server, a scanner, or any suitable computing device capable of performing the techniques described herein.

The system architecture 600 (also referred to as “system” herein) includes an AI server 622 including a generative model (GM) 620 (also referred to herein as a generative AI model). GM 620 can be trained based on a corpus of data, as described herein.

A generative AI model can deviate from a machine learning model based on the generative AI model's ability to generate new, original data, rather than making predictions based on existing data patterns. In some instances, a GAN, a VAE, and/or other types of generative AI models can employ a different approach to training and/or learning the underlying probability distribution of training data, compared to some machine learning models.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

With respect to GM 620 (and/or AI model 145), GM 620 can be trained by AI server 622 (or another server or computing device of system 600), in some embodiments. In an illustrative example, a training set generator (not shown) of AI server 622 can initialize a training set T to null (e.g., { }). In some embodiments, the training set generator can identify data corresponding to a user input provided by a user of a platform (e.g., a user of platform 170 or another platform). In some embodiments, the user input may be provided by the user when the user is engaging with PMSS. The training set generator can determine whether the user input corresponds to a request category type, communication, data, or operation, pertaining to a PMSS. In some embodiments, the training set generator can determine whether the user input corresponds to a request category type, communication, data, or operation pertaining to a PMSS based on input provided by a developer and/or engineer of system 600 (e.g., via a client device 640). The training set generator (and/or an evaluation engine) can determine whether the user input corresponds to request category type, communication, data, or operation, based on pre-established pairings, or determining whether the one or more actions (e.g., of a set of actions) were performed with respect to the PMSS in connection with the user input.

The training set generator can generate an input/output mapping, in some embodiments. The input can be based on the identified data that includes the user inputs and the outputs can indicate whether the user inputs correspond to a category type, communication, data, or operation pertaining to a PMSS (e.g., in accordance with the determination by the training set generator). The training set generator can add the input/output mapping to the training set T and can determine whether training set T is sufficient for training GM 620. Training set T can be sufficient for training GM 620 if training set T includes a threshold amount of input/output mappings, in some embodiments. In response to determining that training set T is not sufficient for training, the training set generator can identify additional data that indicates additional phrases provided by users of platform 170 and can generate additional input/output mappings based on the additional data. In response to determining that training set T is sufficient for training, the training set generator can provide training set T to GM 620. In some embodiments, the training set generator provides the training set T to a training engine or evaluation engine.

As mentioned above, GM 620 can be trained to determine the context of a given input text through its ability to analyze and understand surrounding words, phrases, and patterns within the given input text. The training set generator can identify or otherwise obtain sentences (or parts of sentences) of user inputs provided by users of platform 170, in some embodiments. The user inputs (e.g., audio phrases, textual phrases, etc.) can be provided during use of a PMSS and/or while the users access other applications provided by the platform 170. The user inputs can be included in content produced or retrieved from other sources of the Internet and/or any other database accessible by the training set generator and/or GM 620. The training set generator can generate an input/output mapping based on the obtained sentences (or parts of sentences). The input can include a portion of an obtained sentence of a phrase. Another portion of the obtained sentence or phrase is not included in the input. The output can include the complete sentence (or part of the sentence), which includes both the portion included in the input and the additional portion that is not included in the input. In accordance with embodiments of the present disclosure, the training set generated by the training set generator to train GM 620 can include a significantly large amount of input/output mappings (e.g., millions, billions, etc.). In some embodiments, multiple input/output mappings of the training set can correspond to the same sentence (or part of the sentence), where the input of each of the input/output mappings include a different portion of the sentence (or part of the sentence).

In some embodiments, the sentences used to generate the input/output mapping of the training set can be obtained from phrases included in electronic documents (e.g., collaborative electronic documents, web page documents, etc.). In such embodiments, the training set generator can determine a context of one or more portions of content of an electronic document. For example, the training set generator can provide a portion of content as input to another machine learning model that is trained to predict a context of the content. The training set generator can update an input/output mapping corresponding to the sentence included in the electronic document to include the determined context. In other or similar embodiments, the training set generator can update the input/output mapping for the sentence to include an indicator of the electronic document (e.g., a pointer or link to the document, a memory address or a web address for the electronic document).

A training engine (not shown) can train GM 620 using the training data (e.g., training set T) from the training set generator. A validation engine (not shown) may be capable of validating a GM 620 using a corresponding set of features of a validation set from the training set generator. The validation engine may determine an accuracy of each of the trained GMs 620 based on the corresponding sets of features of the validation set. The validation engine may discard a trained GM 620 that has an accuracy that does not meet a threshold accuracy. In some embodiments, a selection engine not shown) may be capable of selecting a GM 620 that has an accuracy that meets a threshold accuracy. In some embodiments, the selection engine may be capable of selecting the trained GM 620 that has the highest accuracy of the trained GMs 620.

A testing engine (not shown) may be capable of testing a trained GM 620 using a corresponding set of features of a testing set from the training set generator. For example, a first trained GM 620 that was trained using a first set of features of the training set may be tested using the first set of features of the testing set. The testing engine may determine a trained GM 620 that has the highest accuracy of all of the trained machine learning models based on the testing sets.

It should be noted that AI server 622 can train the GM 620 in accordance with embodiments described herein and/or in accordance with other techniques for training a large language model. For example, GM 620 may be trained on a large amount of data, including prediction of one or more missing words in a sentence, identification of whether two consecutive sentences are logically related to each other, generation of next texts based on prompts, etc.

In some embodiments, data store 610 (database, data warehouse, etc.) may store any suitable raw and/or processed data, e.g., content data 612. For example, content data 612 may include any communications content associated with a PMSS, including communications, audio, text, impression, emojis, etc. Content data 612 may also include user's consent to store user's content data and/or use user's data in information exchanges with generative model (GM) 620. Data store 610 may further store content metadata 612.

System 600 may further include a data manager (DM) 660 that may be any application configured to manage data transport to and from data store 610, e.g., retrieval of data and/or storage of new data, indexing data, arranging data by user, time, type of activity to which the data is related, associating the data with keywords, and/or the like. DM 660 may collect data associated with various user activities, e.g., content pertaining to a PMSS, applications, internal tools, and/or the like. DM 660 may collect, transform, aggregate, and archive such data in data store 610. In some embodiments, DM 660 may support a suitable software that, with user's consent, resides on client device(s) 640 and tracks user activities. For example, the DM-supported software may capture user-generated content and convert the captured content into a format that can be used by various content destinations. Generating, tracking, and transmitting data may be facilitated by one or more libraries of DM 660. In some embodiments, data may be transmitted using messages in the JSON format. A message may include a user digital identifier, a timestamp, name and version of a library that generated the message, page path, user agent, operating system, settings. A message may further include various user traits, which should be broadly understood as any contextual data associated with user's activities and/or preferences. DM 660 may track different ways the same user DM 660 may facilitate data suppression/deletion in accordance with various data protection and consumer protection regulations. DM 660 may validate data, convert data into a target format, identify and eliminate duplicate data, and/or the like. DM 660 may aggregate data, e.g., identify and combine data associated with a given user in the user's profile (user's persona), and storing the user's profile on a single memory partition. DM 660 may scan multiple user's profiles to identify and group users that are related to the same organization, activity, interests, and/or the like. DM 660 may scan numerous user's actions and identify user's profiles associated with multiple uses of a particular resource. DM may ensure reliable delivery of data from user profiles (user personas) to recipients of that data, e.g., by tracking and re-delivering (re-routing) data whose transmission failed.

Data store 610 may be implemented in a persistent storage capable of storing files as well as data structures to perform identification of data, in accordance with embodiments of the disclosure. Data store 610 may be hosted by one or more storage devices, such as main memory, magnetic or optical storage disks, tapes, or hard drives, network-attached storage (NAS), storage area network (SAN), and so forth. Although depicted as separate from the server machine 630, data store 610 may be part of server machine 630, and/or other devices. In some embodiments, data store 610 may be implemented on a network-attached file server, while in other embodiments data store 610 may be implemented on some other types of persistent storage, such as an object-oriented database, a relational database, and so forth, that may be hosted by one or more different machines coupled to server machine 630 via network 601.

Server machine 630 may include QT 631 configured to perform automated identification and facilitate retrieval of relevant and timely contextual information for quick and accurate processing of user queries by generative model 620, as disclosed herein. It can be noted that a user's request for an operation pertaining to a PMSS can be formed into a query that uses QT 631 in some embodiments. Via network 601, QT 631 may be in communication with one or more client devices 640, AI server 622, and data store 610, e.g., via DM 660. Communications between QT 631 and AI server 622 may be facilitated by GM API 632. Communications between QT 631 and data store 610/DM 660 may be facilitated by DM API 634. Additionally, GM API 632 may translate various queries generated by QT 631 into unstructured natural-language format and, conversely, translate responses received from generative model 620 into any suitable form (including any structured proprietary format as may be used by QT 631). Similarly, DM API 634 may support instructions that may be used to communicate data requests to DM 660 and formats of data received from data store 610 via DM 660.

A user may interact with QT 631 via a user interface (UI) 642. In some embodiments, UI 642 may be similar to UI 112 of FIG. 1. In some embodiments, UI 642 may be implemented in UI 112 of FIG. 1. For example, UI 642 can be a UI element of UI 112. UI 642 may support any suitable types of user inputs, e.g., content from one or more UI elements, speech inputs (captured by a microphone), text inputs (entered using a keyboard, touchscreen, or any pointing device), camera (e.g., for recognition of sign language, upload of documents such as receipts, bills, insurance documents, or photographs of buildings, units, or amenities related to them), and/or the like, or any combination thereof. UI 642 may further support any suitable types of outputs, e.g., speech outputs (via one or more speakers), text, graphics, file for a word editing application, and/or the like, or any combination thereof. In some embodiments, UI 642 may be a web-based UI (e.g., a web browser-supported interface), a mobile application-supported UI, or any combination thereof. UI 642 may include selectable items. In some embodiments, UI 642 may allow a user to select from multiple (e.g., specialized in particular knowledge areas) generative models 620. UI 642 may allow the user to provide consent for QT 631 and/or generative model 620 to access user data previously stored in data store 610 (and/or any other memory device), process and/or store new data received from the user, and the like. UI 642 may allow the user to withhold consent to provide access to user data to QT 631 and/or generative model 620. In some embodiments, user inputs entered via UI 642 may be communicated to QT 631 via a user API 644. In some embodiments, UI 642 and user API 644 may be located on client device 640 that the user is using to QT 631.

QT 631 may include a user query analyzer 633 to support various operations of this disclosure. For example, user query analyzer 633 may receive a user input, e.g., user query, and generate one or more intermediate queries to generative model 620 to determine what type of user data GM 620 might need to successfully respond to user input. Upon receiving a response from GM 620, user query analyzer 633 may analyze the response, form a request for relevant contextual data for DM 660, which may then supply such data. User query analyzer 633 may then generate a final query to GM 620 that includes the original user query and the contextual data received from DM 660. In some embodiments, user query analyzer 633 may itself include a lightweight generative model that may process the intermediate query (ies) and determine what type of contextual data may have to be provided to GM 620 together with the original user query to ensure a meaningful response from GM 620.

QT 631 may include (or may have access to) instructions stored on one or more tangible, machine-readable storage media of server machine 630 and executable by one or more processing devices of server machine 630. In one embodiment, QT 631 may be implemented on a single machine (e.g., as depicted in FIG. 6). In some embodiments, QT 631 may be a combination of a client component and a server component. In some embodiments QT 631 may be executed entirely on the client device(s) 640. Alternatively, some portion of QT 631 may be executed on a client computing device while another portion of QT 631 may be executed on server machine 630.

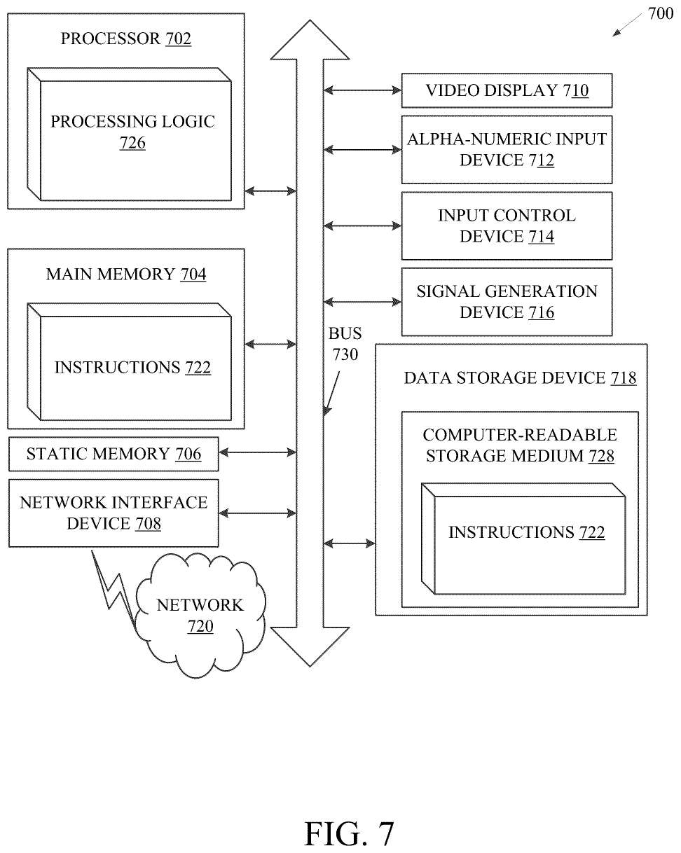

FIG. 7 illustrates an embodiment of a diagrammatic representation of a computing device and/or processing device 700 associated with a substrate manufacturing system. In one implementation, the processing device 700 may be a part of any device or system of FIG. 1, or any combination thereof. Example processing device 700 may be connected to other processing devices in a LAN, an intranet, an extranet, and/or the Internet. The processing device 700 may be a personal computer (PC), a set-top box (STB), a server, a network router, switch or bridge, or any device capable of executing a set of instructions (sequential or otherwise) that specify actions to be taken by that device. Further, while only a single example processing device is illustrated, the term “processing device” shall also be taken to include any collection of processing devices (e.g., computers) that individually or jointly execute a set (or multiple sets) of instructions to perform any one or more of the methods discussed herein.

Example processing device 700 may include a processor 702 (e.g., a CPU), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which may communicate with each other via a bus 730.

Processor 702 represents one or more general-purpose processing devices such as a microprocessor, central processing unit, or the like. More particularly, processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. In accordance with one or more aspects of the present disclosure, processor 702 may be configured to execute instructions.

Example processing device 700 may further include a network interface device 708, which may be communicatively coupled to a network 720. Example processing device 700 may further include a video display 710 (e.g., a liquid crystal display (LCD), a touch screen, or a cathode ray tube (CRT)), an alphanumeric input device 712 (e.g., a keyboard), an input control device 714 (e.g., a cursor control device, a touch-screen control device, a mouse), and a signal generation device 716 (e.g., an acoustic speaker).

Data storage device 718 may include a computer-readable storage medium (or, more specifically, a non-transitory computer-readable storage medium) 728 on which is stored one or more sets of executable instructions 722. In accordance with one or more aspects of the present disclosure, executable instructions 722 may include executable instructions.

Executable instructions 722 may also reside, completely or at least partially, within main memory 704 and/or within processor 702 during execution thereof by example processing device 700, main memory 704 and processor 702 also constituting computer-readable storage media. Executable instructions 722 may further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

It should be understood that the above description is intended to be illustrative, and not restrictive. Many other embodiment examples will be apparent to those of support module in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware or code set forth above may be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but may refer to different and distinct embodiments, as well as potentially the same embodiment.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. The essential elements of a digital computer are a central processing unit for performing or executing instructions and one or more memory devices for storing instructions and digital data. The central processing unit and the memory can be supplemented by, or incorporated in, special purpose logic circuitry. Generally, a digital computer will also include, or be operatively coupled to receive digital data from or transfer digital data to, or both, one or more mass storage devices for storing digital data, e.g., magnetic, magneto-optical disks, optical disks, or systems suitable for storing information. However, a digital computer need not have such devices.

Digital computer-readable media suitable for storing digital computer program instructions and digital data include all forms of non-volatile digital memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks.

Control of the various systems described in this specification, or portions of them, can be implemented in a digital computer program product that includes instructions that are stored on one or more non-transitory machine-readable storage media, and that are executable on one or more digital processing devices. The systems described in this specification, or portions of them, can each be implemented as an apparatus, method, or system that may include one or more digital processing devices and memory to store executable instructions to perform the operations described in this specification.

While this specification contains many specific embodiment details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, from a client device connected to a property management software system (PMSS), a first communication indicating a request pertaining to a PMSS;
determining a category type associated with the request;
routing, using a chat module, the first communication to a first support module configured to perform support operations associated with the category type of the request;
performing, via the first support module, a first support operation associated with the request;
receiving, at the chat module, a first machine communication from the first support module associated with an output of the first support operation;
providing, using the chat module, the first communication and first machine communication as an input to a generative AI model;
obtaining an output of the generative AI model; and
providing, using the output of the generative AI model, a response to the indicated request through a user interface (UI) of the client device.

2. The method of claim 1, wherein determining a category type associated with the request comprises:
performing semantic analysis to generate semantic data indicative of a category type of the request, wherein performing semantic analysis to generate semantic data comprises extracting natural language entity data from the first communication.

3. The method of claim 2, wherein determining a category type associated with the request further comprises:
determining an intention of the request based on the extracted entity data, and matching the intention with a category type based on at least one of keyword matching based on a set of previously established keyword pairings, or an output of a classifier neural network.

4. The method of claim 1, wherein the request comprises at least one of:
a request to summarize a document,
a request to provide instructions,
a request to send a communication,
a request to draft a document,
a request to provide a report comprising data associated with the PMSS,
a request to generate a marketing description,
a request to perform an action within the PMSS,
a request to receive a link to a prebuilt report, or
a request to generate a response to one or more questions.

5. The method of claim 1, wherein the first support operation comprises at least one of:
retrieving data from a database, or
invoking an API.

6. The method of claim 5, wherein retrieving data from a database comprises at least one of:
retrieving one or more documents from an unstructured database associated with the PMSS,
retrieving structured data from a structured database associated with the PMSS.

7. The method of claim 5, wherein retrieving data from a database further comprises mapping the request to a database query via a previously generated database schema.

8. The method of claim 5, wherein invoking an external API comprises mapping the request to one or more external API calls via a previously generated external API schema.

9. The method of claim 1, wherein the first machine communication is at least one of a response to one or more questions, data retrieved from a database, a follow-up question related to the request, or a confirmation that the one or more support operations have been performed.

10. The method of claim 1, wherein the response to the indicated request is at least one of a response to one or more questions, a follow-up question related to the request, or a confirmation that the one or more support operations have been performed.

11. The method of claim 1, wherein the first support module is one of a plurality of support modules associated with a plurality of request category types, wherein each support module of the plurality of support modules is configured to perform support operations associated with one or more category types of the plurality of category types.

12. The method of claim 1, further comprising:
routing, using the chat module, the first communication to a second support module configured to perform support operations associated with the category type of the request;
performing, via the second support module, a second support operation associated with the request;
receiving, at the chat module, a second machine communication from the second support module associated with an output of the second support operation; and
providing, using the chat module, the first communication and second machine communication as an input to a generative AI model.

13. The method of claim 1, further comprising:
performing, via the first support module, a second support operation associated with the request;
receiving, at the chat module, a second machine communication from the first support module associated with an output of the second support operation; and
providing, using the chat module, the first communication and second machine communication as an input to a generative AI model.

14. The method of claim 1, wherein the generative AI model has been trained on a corpus of text to create a foundation model.

15. The method of claim 1, wherein the generative AI model has been fine-tuned on proprietary organizational data associated with property management.

16. The method of claim 1, wherein the generative AI model has been fine-tuned for application to PMSSs.

17. The method of claim 1, wherein a retrieval component of a retrieval-augmented generation (RAG) system provides context associated with the request to the generative AI model.

18. A system comprising:
a memory device; and
a processing device communicatively coupled to the memory device, wherein the processing device is to:
receive, from a client device connected to a property management software system (PMSS), a device communication indicating a request pertaining to a PMSS;
determine a category type associated with the request;
route, using a chat module, the communication to a support module configured to perform support operations associated with the category type of the request;
perform, via the support module, one or more support operations associated with the request;
receive, at the chat module, a machine communication from the support module associated with an output of one or more performed support operations;
provide, using the chat module, the device communication and machine communication as an input to a generative AI model;
obtain an output of the generative AI model; and
provide, using the output of the generative AI model, a response to the indicated request through a user interface (UI) of the client device.

19. A non-transitory computer readable storage medium comprising instructions that, when executed by a processing device, causes the processing device to perform operations comprising:
receiving, from a client device connected to a property management software system (PMSS), a device communication indicating a request pertaining to a PMSS;
determining a category type associated with the request;
routing, using a chat module, the communication to a support module configured to perform support operations associated with the category type of the request;
performing, via the support module, one or more support operations associated with the request;
receiving, at the chat module, a machine communication from the support module associated with an output of one or more performed support operations;
providing, using the chat module, the device communication and machine communication as an input to a generative AI model;
obtaining an output of the generative AI model; and
providing, using the output of the generative AI model, a response to the indicated request through a user interface (UI) of the client device.
